(19) United States
(12) Patent Application Publication
(10) Pub. No.: US 2026/0275119 A1
(43) Pub. Date: Sep. 17, 2026

(54) TIRE FOAM AND TIRE SHINE AEROSOL

(71) Applicant: Energizer Auto, Inc., St. Louis, MO (US)

(72) Inventors: Rajeev Menon, St. Louis, MO (US); Dana Abuzaid, St. Louis, MO (US); Joseph Chiarelli, St. Louis, MO (US); Jaeho Kim, St. Louis, MO (US)

(73) Assignee: Energizer Auto, Inc., St. Louis, MO (US)

(21) Appl. No.: 19/313,426

(22) Filed: Aug. 28, 2025

Related U.S. Application Data
(60) Provisional application No. 63/772,088, filed on Mar. 14, 2025.

(30) Foreign Application Priority Data
Jul. 8, 2025 (WO) PCT/US25/36871

(51) Int. Cl. C09D 5/02; B65B 31/00; C09D 5/08; C09D 7/43; C09D 7/45; C09D 7/61; C09D 7/63; C09D 7/65; C09D 7/80; C09D 183/04

(52) U.S. Cl. CPC C09D 5/021; B65B 31/003; C09D 5/084; C09D 7/43; C09D 7/45; C09D 7/61; C09D 7/63; C09D 7/65; C09D 7/80; C09D 183/04

(57) ABSTRACT

The present disclosure describes compositions for providing shine and durability to various surfaces. The compositions of the present disclosure include: water; one or more thickeners; one or more wetting agents; one or more corrosion inhibitors; one or more pH adjusters; and one or more gloss enhancers or a combination of gloss enhancers and silicone solvent. The compositions can optionally include one or more preservatives, and/or one or more propellants. In embodiments, when the gloss enhancers have a viscosity of greater than about 500 cSt, a silicone solvent is added. In embodiments, if foaming is desired, the compositions can include one or more surfactants.

### CROSS-REFERENCE TO RELATED APPLICATIONS

This application claims the benefit of U.S. Provisional Application No. 63/772,088, filed Mar. 14, 2025, and International Application No. PCT/US2025/036871, filed Jul. 8, 2025, which are incorporated herein by reference in their entirety.

### FIELD OF THE DISCLOSURE

The present disclosure relates to compositions for treating elastomeric surfaces of vehicles to enhance the shine and/or gloss of the surface. More particularly, the compositions for treating elastomeric surfaces are quick drying and provide durable shine and gloss to the surface.

### BACKGROUND OF THE DISCLOSURE

The shine and glossy appearance of a vehicle is an important characteristic because it indicates a clean, new, and/or well-maintained vehicle, which can significantly increase the vehicle's aesthetic appeal and value. Elastomeric surfaces, such as tires, trim, and plastic components on the exterior of a vehicle, however, tend to lose their shine and glossy appearance rapidly over time due to contaminants and degradation of the materials from environmental conditions such as ultraviolet (UV) radiation and extreme cold and/or heat. Therefore, is a considerable market for “tire shine” compositions that can restore the shine and glossy appearance of the exterior plastic and rubber components of vehicles.

Tire shine compositions on the market aim to enhance the overall aesthetic of the vehicle by providing a deep, dark finish to the tires, trim, and plastic surfaces, making them look new and well-maintained. A well-shined tire significantly improves the overall visual appeal of a vehicle, thus complementing the overall look of the car and contributing to a professional “showroom shine” appearance and increasing the value of a vehicle. Tire shine compositions, when applied to exterior plastic and rubber surfaces can also help repel contaminants, such as dirt and brake dust, making it easier to clean the surfaces and maintain their appearance. Tire shine compositions can also act as a protective layer against ultraviolet (UV) rays and environmental elements, preventing surfaces, such as the tire sidewall, from fading and cracking.

Previous tire shine compositions on the market typically use silicone polymers, in the form of low molecular weight silicone oil, to provide shine and to form a barrier against environmental contaminants and harmful UV rays. Tire shine compositions on the market, however, have a number of significant limitations. For example, these compositions are slow drying, taking 15 minutes or more to completely dry and deposit the silicone polymers on the surface. Slow drying times are inefficient and inconvenient for consumers, often leading to insufficient drying of the surface prior to operation of the vehicle resulting in “sling off” of the product as the tires spin and as wind passes over the exterior surfaces of the vehicle. In addition to excessive drying times, prior compositions do not last as long as customers would hope. Despite applying these tire shine products as instructed, the glossy appearance fades within a few days, leaving tires looking dull and lackluster. There are no tire shine compositions on the market that can provide fast drying times and long-lasting gloss and protection to tires, trim, and other elastomeric surfaces on the exterior of a vehicle.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes compositions for treating surfaces, including elastomeric surfaces of vehicles to enhance the shine and/or gloss of the surface. More particularly, the compositions for treating elastomeric surfaces are quick drying and provide durable shine and gloss to the surface. In embodiments, the compositions can also clean the surfaces.

The compositions of the present disclosure can also include: water; one or more thickeners; one or more wetting agents; one or more corrosion inhibitors; one or more pH adjusters; and one or more gloss enhancers or a combination of gloss enhancers and silicone solvent. The compositions can optionally include one or more preservatives, and/or one or more propellants.

The preset disclosure describes compositions including water; one or more thickeners; one or more wetting agents; one or more corrosion inhibitors; one or more pH adjusters; one or more silicone oils having a viscosity of about 1 to 500 cSt or a blend including one or more silicone oils having a viscosity of between about 500 cSt to 2,000,000 cSt and one or more silicone solvent; and optionally, one or more preservatives and/or one or more propellants.

The compositions of the present disclosure can include: water; one or more thickeners; one or more wetting agents; one or more corrosion inhibitors; one or more pH adjusters; one or more gloss enhancers; and one or more nonionic surfactants. The compositions can optionally include one or more preservatives and/or one or more propellants.

The compositions of the present disclosure can include: water; one or more thickeners; one or more wetting agents; one or more corrosion inhibitors; one or more pH adjusters; one or more gloss enhancers; and one or more silicone solvents. The compositions can optionally include one or more preservatives, and/or one or more propellants.

The water can include deionized water. The one or more thickeners can include PEMULEN 1622, PEMULEN 1621, CARBOPOL 690, CARBOPOL 672, CARBOPOL 694, CARBOPOL 676, CARBOPOL 690, CARBOPOL 674, CARBOPOL 691, CARBOPOL ETD 2691, CARBOPOL EZ-2, or CARBOPOL EZ-5, or combinations thereof. The one or more wetting agents can include ELKAY 7302, The one or more corrosion inhibitors can include sodium nitrite. The one or more pH adjusters can include morpholine. The one or more gloss enhancers can include silicone oil having 0.5 to 2 million centistokes (cSt), for example 350 cSt, 1000 cSt, or 12,500 cSt. The one or more nonionic surfactants can include T-Det® A 900. The one or more silicone solvents can include cyclopentasiloxane. The one or more preservatives can include TROYGUARD. The one or more propellants can include A-70 Propellant.

The compositions of the present disclosure can also optionally include one or more fragrance, one or more UV inhibitors, or one or more aesthetic agents, such as dyes, lustrous particles, and/or mattifying agents.

### BRIEF DESCRIPTION OF THE DRAWINGS

FIG. 1 shows foam flow down observations on tires for current compositions on the market (Comparative Example 1 and Comparative Example 3), a modified composition of Comparative example 1 (Comparative Example 2), and an exemplary composition of the present disclosure (Example Composition 1).

FIG. 2 shows gloss reading analysis for each composition tested in FIG. 1.

FIG. 3 shows observation images of the styrene butadiene rubber (SBR) panels measured in FIG. 2.

FIG. 4 shows observational images of gloss and wash durability on SBR surfaces.

FIG. 5 shows foam flow down observations on tires for current compositions on the market (Comparative Examples 2 and 3) and exemplary compositions of the present disclosure (Example Composition 1 and Example Composition 2).

FIG. 6 shows gloss reading analysis for each composition tested FIG. 5.

FIG. 7 shows observation images of the SBR panels measured in FIG. 6.

FIG. 8 shows observation images of wash durability of compositions currently on the market (Comparative Examples 1 and 3) and an exemplary composition X of the present disclosure (Example Composition 2).

FIG. 9 shows the improved deposition and drying time of an exemplary composition (Example Composition 2) of the present disclosure compared to a composition currently on the market (Comparative Example 1).

FIG. 10 shows gloss reading analysis for a known tire shine composition (Comparative Example 4) and an exemplary composition of the present disclosure (Example Composition 3).

FIG. 11 shows SBR observational images of the gloss and wash durability for the compositions tested in FIG. 10.

FIG. 12 shows observational images of gloss and wash off durability for each composition tested in FIG. 10.

FIGS. 13A and 13B show observational comparisons of the performance of two exemplary compositions of the present disclosure (Example Composition 3 and Example Composition 4) and a composition currently on the market (Comparative Example 5) on a first car (FIG. 13A) and a second car (FIG. 13B).

FIG. 14 shows analysis of the deposition of sprayed compositions versus drying time on a rubber panel. Compositions include a tire foam composition currently on the market (Comparative Example 1) and an exemplary tire foam composition of the present disclosure (Example Composition 2).

FIG. 15 shows analysis of the deposition of sprayed compositions versus drying time on a rubber panel. Compositions include a tire shine composition currently on the market (Comparative Example 4) and an exemplary tire shine composition of the present disclosure (Example Composition 3).

FIGS. 16A and 16B show analysis of average sling off of about 2.2-2.6 grams (FIG. 16A) and 3.2-3.6 grams (FIG. 16B) of tire shine compositions on rubber panels. Compositions include a tire shine composition currently on the market (Comparative Example 4) and an exemplary tire shine composition of the present disclosure (Example Composition 3).

FIG. 17 shows performance of a composition of the present disclosure (Example Composition 2) on a dusty surface.

FIGS. 18A and 18B show foam flow down observations on tires of a first car (FIG. 18A) and a second car (FIG. 18B).

FIGS. 19A and 19B show wash durability observations on clean tires of a first car (FIG. 19A) and a second car (FIG. 19B).

FIGS. 20A and 20B show wash durability observations on unclean tires of a first car (FIG. 20A) and a second car (FIG. 20B).

FIG. 21 shows gloss analysis using SBR panels. FT is freeze & thaw. 50 C is 50 degrees Celsius. RT is room temperature.

FIG. 22 shows gloss and wash durability observations on SBR panels.

FIG. 23 shows spin and wash durability observations on SBR panels.

FIG. 24 shows dust masking performance observations on SBR panels.

FIG. 25 shows observations of example compositions of the present disclosure including mattifying agents. A first example composition (Ex 1) is the composition of Example Composition 3, and Ex M1 is an exemplary composition of the present disclosure which includes 0.5 wt % of mattifying agent, and Ex M2 is an exemplary composition of the present disclosure which includes 1 wt % of mattifying agent.

### DETAILED DESCRIPTION

The present disclosure describes methods and compositions for treating elastomeric surfaces of vehicles to enhance the shine and/or gloss of the surface. More particularly, the compositions of the present disclosure provide fast drying times and long-lasting gloss and protection on elastomeric surfaces, for example on the exterior and interior of a vehicle. Elastomeric surfaces can include tire, trim, plastic, vinyl, and leather surfaces. In embodiments, a surface suitable for application of the compositions described herein include tires, trim, and other elastomeric surfaces found on the exterior of a vehicle. In the context of the present disclosure, a vehicle includes a car, truck, bus, train, airplane, boat.

Compositions of the present disclosure address application, gloss, and improve durability and protection compared to prior tire shine compositions. Compositions described herein provide easy one step aerosol spray application, with no mess, and no wiping required. Application of the compositions described herein is extremely fast and efficient, for example compositions can be applied evenly to a surface and can deposit a rich, durable, and protective gloss to the surface in a matter of seconds. Compositions described herein provide a maximum wet black shine finish and uniquely formulated extra gloss enhancers provide intense and even gloss and shine. Compositions of the present disclosure satisfy consumer need for a durable tire shine product to provide long-lasting gloss, color-depth, and protection, for example lasting for at least 2 washes and depending on the components the compositions, such as the silicone oil used, are durable for 4 or more washes. The increased viscosity of the silicone oil in the composition can enhance the durability to 6 or more washes. In embodiments, the compositions provided herein are durable and lasts for about 2, 3, 4, 5, 6, 7, 8, 9, or 10 washes. Compositions of the present disclosure also preserve the durability of a surface, offering protection from cracking and fading, preserving the rich black look of the surface.

Silicone polymers are effective ingredients to provide shine and to form a barrier against environmental contaminants and harmful UV rays. Low molecular weight silicone polymers, such as low molecular weight silicone oils, have a liquid consistency that are used in foaming tire shine compositions currently on the market. Silicone oils, however, are not water soluble and therefore thickeners and/or surfactants are needed to disperse the silicone oil in water. Thickeners, such as polymers, can be used, and surfactants can be added for emulsification of the oil in water.

The primary reason tire shine compositions on the market have long drying times is due to the time it takes for the water to dry from the oil in water emulsion, or from the oil/water/suspending polymer emulsion, after the composition has been applied to a surface. Drying times will also depend on the environment in which the tire shine composition is applied, for example compositions will dry faster in hot and/or arid environments than in cold and/or humid environments. Methods to accelerate the drying process include increasing the ambient temperature, such as by drying in sunlight, and using a sponge to apply the product which can absorb moisture and leave behind the oil and polymers on the surface of the tire. These methods are not always possible or ideal for consumers, however. For example, an elevated temperature and sunlight are not always available depending on a customer's geographic location and the environmental conditions. Many consumers may be limited to or prefer to apply the product in a covered area, such as a garage. Additionally, using a sponge to apply and dry a tire shine composition requires more work compared to simply spraying the product on the tire.

The slow drying time of current tire shine compositions on the market is a significant problem that is inefficient and inconvenient for consumers. Often customers have limited time to wait for the product to dry, and drying times may vary depending on environmental conditions of the vehicle. Additionally, there isn't a way for the consumer to know if the product has sufficiently dried, other than touching the tire and knowing the texture of the composition that has been applied. If the tire shine composition is not sufficiently dry prior to operation of the vehicle, there is a high likelihood that the applied product will sling off as the tires spin and as wind passes over the exterior surfaces of the vehicle. Sling off reduces the amount of gloss and shine that a vehicle surface can achieve and reduces the durability of the tire shine product. Also, sling off that contains water, oil, emulsifiers, and suspending polymers from the tire shine composition can transfer from the intended surface, such as a tire, and on to painted surfaces of the vehicle, affecting the aesthetics of the vehicle.

One solution to decrease the drying time of tire shine compositions is to use a solvent based formula, such as hydrocarbon-based solvents mixed with silicone oil. Some examples include petroleum distillates, acetone, methyl acetate, etc. These solvents are typically faster to dry compared to water; however, they are generally not considered environmentally friendly. Also, if the overspray of a hydrocarbon based solvent product hits certain plastics, trim and/or paint of a vehicle, this can lead to surface safety issues and damage to the surface.

The primary reason prior tire shine compositions fade within a few days of applying is because they are not wash durable—i.e., they wash off quickly when exposed to water such as rain, puddles, a car wash, or a simple splash of water. This is because the ingredients used in emulsifying the silicone oils, such as surfactants, thickening polymers, suspending polymers, and emulsifying polymers, dry on the surface along with the silicone oils. Therefore, when the surface is exposed to water again through rinsing, rain, or a car wash, the surfactants will rehydrate and emulsify the silicone oils again, allowing them to be easily washed off from the surface.

It is known in the industry that using higher molecular weight silicone oil is generally beneficial when it comes to wash durability from car surfaces. For the context of this disclosure, high molecular weight silicone includes silicone oil with a viscosity greater than or equal to 1000 centistokes (cSt). Some examples of commodity high molecular weight silicone oils that are available and are cost effective are Silicone 1000 cSt, Silicone 12,500 cSt, Silicone 60,000 cSt. For the context of this disclosure, Silicone 350 cSt is considered as a low molecular weight silicone oil compared to silicone oil with a viscosity of 1000 cSt or more. Higher molecular weight silicone oils tend to be more wash durable because they are tackier and/or stickier than low molecular weight oils and therefore are harder to wash off from the treated surface, typically requiring strong degreasers or physical abrasion to remove. Despite this known benefit, the practical implementation of formulating high molecular weight silicone oils into tire shine compositions on the market has proven to be difficult. For example, high molecular weight silicone oils are difficult to incorporate into an aerosol spray due to increased clogging of the spray valve, and their method of application has been limited to trigger spray and sponge-based products formulated in a water-based system. High molecular weight silicone oil tire shine compositions typically require large amounts of surfactants, thickening polymers, suspending polymers, and emulsifying polymers leading to similar issues of long drying time and wash durability due to the rehydration of these components.

As mentioned, silicone oil is not soluble in water and therefore are typically held together in a composition using emulsification with surfactants or with a combination of surfactants and/or thickeners. As the molecular weight of the silicone oil increases, more surfactants are needed, along with particle size reducing homogenizers, in order to ensure that the silicone oil is able to be emulsified properly in water. Another way to do this is to use thickeners such as polymers that are also emulsifiers, but in order to suspend high molecular weight silicone, the compositions generally need to be highly viscous. A highly viscous composition in the present disclosure includes 1000 centistokes (cSt) or higher. Although increasing viscosity of the composition is generally not a problem when it comes to trigger spray and sponge pad application (i.e., a bottle with product is provided and applied on the sponge which is then applied to the surface), aerosol and wipe-based products require relatively low viscosity, for example, 200 cSt or less. In the case of aerosol spray products, low viscosity is needed in order the product to be able to be sprayed effectively and for wipe-based products, low viscosity is needed in order for the product to wick onto the wipe effectively. Aerosol cans using hydrocarbon propellants or compressed gases (nitrogen, oxygen, carbon dioxide) can propel out higher viscosity compositions, but this requires high pressures to be used or the cans would need to carry marbles that can break the viscosity of the product. Both methods can be expensive and unsafe (higher pressures). If emulsifiers and homogenizer are used to emulsify silicone oil in water, the composition can have low viscosity of 200 cSt or less. But high levels of surfactants are required for such emulsification for high molecular weight silicone oils and as mentioned, when products with high levels of surfactants are sprayed onto surfaces, the surfactants dry along with the oil onto the surface, which is susceptible to easy wash off when rinsed with water.

Over time in the market, aerosol-based tire shine products have proven to be the most commercially successful and preferred products among consumers because of their ease of use. Therefore, there is a need to develop tire shine compositions that allow safe and efficient application of high molecular weight silicone oil to vehicle surfaces, such as tires, trim, and other exterior plastic surfaces.

Foaming tire shine compositions on the market typically include low molecular weight silicone, such as Silicone 350, to provide gloss, shine, and protection to a surface. To emulsify the silicone oil in water, the compositions can include various nonionic surfactants, for example C9-C11 ethoxylated alcohols (T-Det® A 900), pro-foaming silicone wetting agents, such as a polyalkylene oxide modified heptamethyltrisiloxane (ELKAY AG 177), and a thickener/stabilizer, such as hydrophobically modified alkali-swellable emulsion (HASE) polymers, for stability. The combination of low molecular weight silicone oil, high foaming surfactants, pro-foaming silicone wetting agents, and HASE polymers result in slow drying times, for example 15 minutes or more, and poor wash durability of the product over time. These compositions, even when applied properly and allowed to dry for the appropriate amount of time, have poor to no durability once exposed to water. Even a small amount of water washes the product off from the surface.

Hydrophobically modified alkali-swellable emulsion (HASE) polymers typically have the chemical structure shown below:

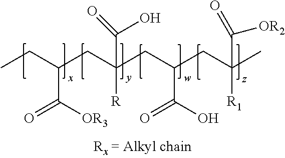

HASE polymers are synthesized from acid/acrylate copolymer backbone and include an ethoxylated hydrophobe. These products are also made through emulsion polymerization.

Examples of HASE polymers include: ACUSOL 801S, ACUSOL 805S, ACUSOL 820, ACUSOL 823, and NOVETHIX L-10.

When HASE polymers such as ACUSOL 801S and Novethix L-10 swell after neutralization, the pendant hydrophobic groups are free to build associations with one another and with other hydrophobes available in the composition, such as surfactants, oils and dyes. This creates a network structure that results in significant viscosity build. Therefore, in compositions of prior foaming tire shine products, HASE polymers (thickeners) form a network like structure with the silicone oil and the wetting agent. The formed HASE polymer matrix holds on to ingredients in the matrix, including water, which results in slow drying time. Once water has time to evaporate, the HASE polymer matrix dries intact as a coating on the surface. When this dried coating is exposed to water, the HASE polymer, being water loving, rehydrates and also pulls out the ingredients stuck in its network structure to resolubilize in the water, leading to wash off of the applied product. High foaming surfactants, such as C9-C11 ethoxylated alcohols (T-Det® A 900), have detergent like properties and when they rehydrate in the HASE polymer matrix, they contribute to wash off of the product. Pro-foaming silicone wetting agents such as ELKAY AG 177, when combined with an HASE polymer matrix also make the dried product susceptible to wash off.

The present disclosure includes novel solutions to composition problems currently available on the market. As described in the present disclosure, the matrix forming HASE polymer is replaced with one or more homopolymers of acrylic acid or copolymers of acrylic acid, for example, one or more carbomers. Carbomers are high molecular weight polymers derived from acrylic acid. Carbomers can include one or more C10-C30 alkyl acrylates, such as PEMULEN 1621 or PEMULEN 1622. In embodiments, a moderately crosslinked, hydrophobically modified acrylic acid copolymer (e.g., PEMULEN 1621) is used. In embodiments, a lightly crosslinked, hydrophobically modified acrylic acid copolymer (e.g., PEMULEN 1622) is used, for example a lightly crosslinked, hydrophobically modified acrylic acid copolymer having the chemical structure shown below:

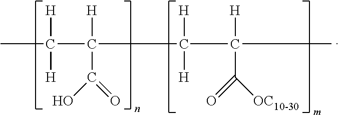

Hydrophobically modified acrylic acid copolymers of the present disclosure can form oil/water emulsions. The lipophilic portion can adsorb at the oil-water interface and the hydrophilic portion swells in the water forming a gel network around oil droplets to provide exceptional emulsion stability.

Unlike HASE polymers, silicone oil adsorbs onto the gel like structure of the acrylic acid polymers and copolymers. It was discovered that the acrylic acid polymer or copolymer structure breaks down when it is sheared by the actuator within the application mechanism (e.g., aerosol spray). This breakdown facilitates the release of water from the silicone oil upon application of the product, allowing most of the water and other ingredients of the composition to separate from the silicone oil when it attaches and dries onto an elastomeric surface. It was observed that, as soon as a silicone oil and acrylic acid polymer or copolymer composition is sprayed and applied to the elastomeric surface, the silicone oil releases from the acrylic acid polymer or copolymer and transfers to surface. This action is due to the silicone oil having a lower affinity towards the acrylic acid polymer or copolymer structure and a higher affinity towards the elastomeric surface. The breakdown of the acrylic acid polymer or copolymer and the separation of the water and other emulsifying ingredients of the composition results in the unexpectedly high wash resistance of the present compositions.

Conversely, HASE polymers of prior compositions on the market are much more shear stable and therefore are less likely to experience a similar breakdown of the polymer matrix upon application, and therefore would not be expected to have the same benefit of releasing the silicone oil upon application. The discovery that acrylic acid polymers or copolymers shear during aerosol application and release the water from the oil in compositions described herein, allowing most of the water to instantaneous flow off of the applied surface while leaving the oil on the applied surface, is a novel solution to decrease drying time.

Additionally, compositions of the present disclosure provide the advantage of high durability by reducing the concentration of wash durability reducing chemicals such as HASE polymers, high foaming surfactants, such as C9-C11 ethoxylated alcohols (T-Det® A 900), and pro-foaming silicone wetting agents such as ELKAY AG 177. Moreover, some of the components of the composition are replaced. As an example, the pro-foaming silicone wetting agent can be replaced with a low foaming silicone wetting agent, such as a dimethylsiloxane, ethylene oxide block copolymer (e.g., ELKAY 7302). A low molecular weight silicone, Silicone 350 cSt, can be replaced with high molecular weight silicone, Silicone 1000 cSt or higher. Moreover, a silicone solvent can be added.

Carbomers that are homopolymers can also be used in compositions of the present disclosure to provide increased durability. In embodiments, the thickener is a homopolymer of acrylic acid, for example CARBOPOL 690, having a chemical formula of (C₃H₄O₂)ₙ. Polyacrylic acid homopolymers, such as CARBOPOL 690, do not include a lipophilic component, and thereby do not have substantial affinity towards silicone oil. Examples of carbomers homopolymers include CARBOPOL 690, CARBOPOL 672, CARBOPOL 694, CARBOPOL 676, CARBOPOL 934, CARBOPOL 910, CARBOPOL 940, CARBOPOL 941, CARBOPOL 990, CARBOPOL 674, CARBOPOL 691, CARBOPOL ETD 2691, CARBOPOL EZ-2, or CARBOPOL EZ-5. In embodiments, a highly crosslinked, polyacrylic acid homopolymer (e.g., CARBOPOL 690, CARBOPOL 676, CARBOPOL EZ-2) is used. In embodiments, alightly crosslinked, polyacrylic acid homopolymer (e.g., CARBOPOL 674, CARBOPOL 691, and CARBOPOL ETD 2691) is used.

The compositions described herein are water-based compositions providing improved durability and faster drying. In embodiments of the present disclosure, the compositions use thickeners including a blend of polyacrylic acid homopolymers, such as CARBOPOL 690, or hydrophobically modified acrylic acid copolymers, such as PEMULEN 1621 or PEMULEN 1622, along with a silicone oil, such as a low molecular weight silicone oil, and a low foaming silicone wetting agent, such as ELKAY 7302. The low foaming silicone wetting agent can help the silicone oil spread on the surface, enhancing the fast setting “touchless” application of the composition.

The compositions described herein also include incorporating higher molecular weight silicone oil, such as silicone oil having about 0.5 to 2 million cSt, in a water based composition. The present disclosure also describes compositions and methods for incorporating high molecular weight silicone oil into aerosol tire shine compositions. Methods described herein include obtaining a preblend including one or more silicone solvents and one or more high viscosity silicone oils before adding to the other components in the composition. The methods include blending high molecular weight silicone oil, for example, having a viscosity of greater than about 500 cSt with a silicone solvent, such as cyclopentasiloxane, so as to lower the viscosity of the silicone oil, for example to a viscosity of about 500 cSt or below. In embodiments, the silicone solvent can be used with a high molecular weight silicone oil to reduce its viscosity. Different amounts of silicone solvent would be required to achieve the desired final viscosity depending on the molecular weight of the initial silicone oil and the weight % (wt %) of silicone oil used in the composition. Once the silicone oil is thinned by the silicone solvent, it is easier to handle and can be suspended using conventional suspending polymers and emulsifiers if needed. In embodiments, the thinned high molecular weight silicone oil can be incorporated into compositions of the present disclosure, using methods described herein.

When the compositions including the silicone solvent are applied to a surface, for example by spraying from an aerosol can, the silicone solvent evaporates off, leaving behind just the high molecular weight silicone on the surface. The high molecular weight silicone oil thereby provides increased durability of gloss, shine, and protection to the surface compared to a low molecular weight silicone oil. In embodiments, an ideal viscosity of the high molecular weight silicone oil and silicone solvent blend is about 400 cSt to 500 cSt at 25° C. It has been shown that viscosity higher than about 500 cSt may introduce problems with clogging the aerosol actuator while spraying.

A silicone solvent can be used in the composition to reduce the viscosity of a high viscosity or high molecular weight silicone oil. When a silicone solvent is used, a high foaming nonionic surfactant is not required.

A neutralizer or pH adjuster, such as morpholine, can be used to activate the polymer, although any alkaline agent can be used. The polymer starts activating above the pH of 5. In embodiments, a morpholine based alkaline agent is used because it is also a good vapor phase corrosion inhibitor (VCI). For lined aerosol cans, a concentration of Morpholine can be about 0.186 w/w % and Sodium Nitrite can be about 0.2325 w/w %. For unlined aerosol cans made with steel and tin, a concentration of Morpholine and Sodium Nitrite can be about 0.5 wt. % each.

A corrosion inhibition, such as sodium nitrite, may be added to prevent corrosion in the aerosol can. The corrosion inhibitor, such as sodium nitrite, may de-swell the thickeners, such as the polymers, and lower the viscosity of the composition. Compositions of the present disclosure can advantageously be modified to adjust levels of the acrylic acid polymers or copolymers accordingly such that, even at low viscosity, the polymer/oil/water mixture holds together for sufficient amount of time, such as about 10-15 mins, for packaging the composition for use and for sale to consumers. In embodiments, compositions of the present disclosure can be packaged into metal aerosol cans which may be shaken prior to use to allow the composition to emulsify optimally for application.

When compositions of the present disclosure are aerosolized and sprayed using an aerosol actuator, the high shear induced by the actuator can break the acrylic acid polymer or copolymer and increase the dissociation of water and silicone oil from one another. The moment the product hits the elastomeric surface, most of the water separates and can be removed, for example by gravity, just leaving behind the silicone oil and the silicone wetting agent on the surface and providing a deep glossy shine in a considerably low time. Because most of the water separates instantly upon spraying the composition from the aerosol can, the product dries quickly on the surface, for example from less than one second to 5 minutes. Fast drying compositions of the present disclosure provide the advantage of reducing sling off from exterior surfaces of a vehicle. Compositions of the present disclosure also provide the advantage of increased durability compared to other water-based aerosol products, because the water-soluble polymer and surfactants do not deposit on the surface.

In embodiments, an aerosol valve and actuator can include a VX-86 valve and VX-XL-200 actuator from Aptar, or an SV-92 valve and V-80 0.02×0.04 actuator from Summit. In embodiments, the aerosol valve and actuator can be chosen in conjunction with a desired propellant to provide optimal application of any one of the compositions described herein.

Compositions of the present disclosure can include components such as water, one or more thickeners, one or more wetting agents, one or more corrosion inhibitors, one or more pH adjusters, and one or more gloss enhancers having a viscosity of about 0.5 to 500 cSt or a combination of gloss enhancers having a viscosity of greater than about 500 cSt and silicone solvent. In embodiments, the viscosity of the gloss enhancers has about 500 to 2,000,000 cSt. Compositions of the present disclosure can optionally include other components including one or more preservatives, one or more propellants, one or more fragrance, one or more UV inhibitors, or one or more aesthetic agents, such as dyes, lustrous particles, and/or mattifying agents.

Compositions of the present disclosure can include water, one or more thickeners, one or more wetting agents, one or more corrosion inhibitors, one or more pH adjusters, one or more gloss enhancers. The compositions can optionally include one or more nonionic surfactants, preservatives, one or more propellants, fragrance, one or more UV inhibitors, or one or more aesthetic agents.

Compositions of the present disclosure can include water, one or more thickeners, one or more wetting agents, one or more corrosion inhibitors, one or more pH adjusters, one or more gloss enhancers, and one or more silicone solvents. The compositions can optionally include one or more preservatives, one or more propellants, one or more fragrance, one or more UV inhibitors, one or more aesthetic agents.

Composition of the present disclosure can also include: deionized water, one or more thickeners, one or more wetting agents, one or more corrosion inhibitors, one or more pH adjusters, one or more gloss enhancers, and one or more nonionic surfactants. The composition can optionally include one or more preservatives, one or more propellants, one or more fragrance, one or more UV inhibitors, one or more aesthetic agents. In embodiments, the one or more thickeners comprise highly crosslinked, polyacrylic acid homopolymer. In embodiments, the one or more nonionic surfactants comprise nonionic surfactant with a HLB from about 6 to 10, about 7 to 10, about 7 to 9, about 8 to 9, about 8, or about 8.7.

The water in the compositions can include distilled water, deionized water, or reverse osmosis water.

The one or more thickeners in the compositions can also be emulsifiers. Examples of thickeners include an acrylic acid homopolymer having the chemical formula (C₃H₄O₂)ₙ, 2-propenoic acid homopolymer, poly(vinyl pyrrolidone/acrylic acid), acrylate polymer, acrylic acid based polymer, and acrylic-acid based copolymer. In embodiments, the acrylic acid based polymer includes highly crosslinked, polyacrylic acid homopolymer, such as 2-propenoic acid homopolymer. In embodiments, the acrylic-acid based copolymer includes crosslinked copolymer of acrylic acid and C10-C30 alkyl acrylate, and optionally wherein the crosslinked copolymer of acrylic acid and C10-C30 alkyl acrylate includes moderately crosslinked, hydrophobically modified copolymer of acrylic acid and C10-C30 alkyl acrylate or lightly crosslinked, hydrophobically modified copolymer of acrylic acid and C10-C30 alkyl acrylate. For example, the one or more thickener can include a highly crosslinked, polyacrylic acid homopolymer, such as CARBOPOL 690, a moderately crosslinked, hydrophobically modified acrylic acid copolymer, such as PEMULEN 1621, and/or a lightly crosslinked, hydrophobically modified acrylic acid copolymer, such as PEMULEN 1622.

The one or more wetting agents in the compositions can include a low foaming wetting agent, for example, a silicone polyether copolymer such as a dimethylsiloxane ethylene oxide block copolymer. In embodiments, the one or more wetting agents can have an HLB of about 8 to about 15. In embodiments, the one or more wetting agents can include ELKAY 7302. The low foaming wetting agent (ELKAY 7302) is a silicone polyether copolymer surfactant used in oil and gas, construction, printing and coatings industries. It acts as an efficient defoaming agent while also promoting wetting properties by reducing surface tension. This gives it the ability to act as a 4-in-1 leveling, wetting, dispersing and defoaming agent in compositions. It can act as a de-emulsifier for crude oils. ELKAY 7302 is both water and alcohol compatible. It is an excellent base for production of silicone surfactant based antifoams. It is a hydrophobic silicone wetting agent.

The one or more corrosion inhibitors in the compositions can an inorganic inhibitor and an organic inhibitor. For example, the one or more corrosion inhibitors can include nitrite, nitrate, phosphate, chromate, and molybdate. In embodiments, the one or more corrosion inhibitors can include a low-odor corrosion inhibitor (LCI or liquid phase corrosion inhibitor), and optionally wherein the LCI includes sodium nitrite. In embodiments, the one or more corrosion inhibitors can include amino acid, alcohol, and amine, and optionally wherein the amine include triethanolamine, dicyclohexylamine, or diisopropyl amine. In embodiments, the corrosion inhibitor is optional to the composition.

The one or more pH adjusters (or neutralizers) in the composition can include nitrogen containing pH adjusting agents. In embodiments, the one or more pH adjusters can include tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine), morpholine, and morpholine derivative. In embodiments, the one or more pH adjusters include volatile corrosion inhibitor (VCI, or vapor phase corrosion inhibitor), and optionally wherein the VCI includes morpholine or a morpholine derivative.

In embodiments, other known corrosion inhibitors can be used instead of, or in combination with sodium nitrite to achieve the desired result. However, if the corrosion inhibition and pH adjustment are not needed, the corrosion inhibitor may be an optional component.

As an example, when a water-based composition is dispensed in an aerosol can made of steel, two types of corrosion inhibitors can be used: a liquid phase corrosion inhibitor (LCI) and a vapor phase corrosion inhibitor (VCI). Examples of liquid phase corrosion inhibitor includes sodium nitrite and sodium benzoate. Examples of vapor phase corrosion inhibitors include secondary and tertiary amines, such as morpholine, triethanolamine, and diisopropylamine. In embodiments, the vapor phase inhibitor is morpholine, Morpholine can play the dual role of vapor phase corrosion inhibitor and pH adjuster.

The one or more preservatives in the compositions can include hydantoin germicide, carbamate fungicide, benzisothiazolinone (BIT), methylisothiazolinone (MIT), and methylchloroisothiazolinone (CMIT). In embodiments, the one or more preservatives can include a combination of BIT, MIT, and CMIT. For example, the one or more preservatives can include TROYGUARD BC11.

The one or more propellants in the compositions can include a hydrocarbon-based propellant or a compressed gas propellant. The addition of a propellant to the composition can be based on whether foam is needed for the product and how strong of a spray flow rate is required for the product. If foaming is required, one or more hydrocarbon-based propellants can be added to the composition, such as Example Composition 1 and Example Composition 2. Hydrocarbon-based propellants include a mixture of hydrocarbons such as propane, butane, and isobutanes. Examples of hydrocarbon-based propellants include A-28, A-31, A-45, A-46, A-70, and A-108 and others. The numbers represent the pressure imparted by the propellant. Propellant pressure controls the foaming characteristics and spray pattern. In embodiments, the one or more hydrocarbon-based propellants include A-70 hydrocarbon propellant which is a blend of propane and isobutane and having a vapor pressure of about 46 pound per square inch gauge (psig) at about 70° F.

If foaming is not needed, for example the Example Composition 3 and Example Composition 4, one or more compressed gas propellants can be added to the composition. Examples of compressed gas propellants include nitrogen propellant or dimethyl ether propellant can be used.

The one or more gloss enhancers in the compositions can include one or more silicone oils. For example, the one or more gloss enhancers can include one or more silicone oils having a viscosity of about 0.5 to 2,000,000 cSt, about 1 to 1,000,000 cSt, about 5 to 500,000 cSt, about 5 to 100,000 cSt, about 10 to 20,000 cSt, about 100 to 18,000 cSt, about 150 to 16,000 cSt, about 200 to 14,000 cSt, about 250 to 13,000 cSt, about 300 to 12,500 cSt, about 350 to 12,000 cSt, about 400 to 10,000 cSt, about 450 to 7,500 cSt, about 500 to 5,000 cSt, about 700 to 2,500 cSt, about 800 to 1,000 cSt, about 300 to 1,100 cSt, about 350 to 1,000 cSt, about 900 to 13,000 cSt, about 1,000 to 12,500 cSt, or about 11,000 to 13,000 cSt. The one or more gloss enhancers can include one or more silicone oils having a viscosity of about 350 cSt, about 1,000 cSt, or about 12,500 cSt.

In embodiments, the one or more gloss enhancers include one or more silicone oils having the formula:

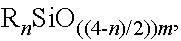

wherein:
n is 0 to 3;
m is 2 or greater; and
R is alkyl, alkylene, allyl, aryl, benzyl, phenyl, amine, amide, vinyl, fluoroalkyl, perfluoroalkane, carboxyester, or quaternary alkyl ammonium.

In embodiments, the one or more gloss enhancers can include one or more polyorganosiloxanes, for example polydimethylsiloxane, polydiethylsiloxane, and/or polyalkylarylsiloxane.

The one or more nonionic surfactants are added to provide foaming action and for emulsifying the one or more gloss enhancers, such as silicone oils, in order to clean a surface, provide shine to a surface, and/or protect a surface. Surfactants are selected for foaming action and dust masking and also for its ability to not affect was durability too much. One or more nonionic surfactants having a hydrophilic-lipophilic balance (HLB) of 8-18 are included in the compositions. Examples of such nonionic surfactants include T-Det® A 900, BEROL 266, BIOSOFT (N25-3, N-900, N91-6, N25-9), MERPOL HCS. The one or more nonionic surfactants can include an ethoxylated nonionic surfactant. Examples of ethoxylated nonionic surfactant include: C9-C11 ethoxylated alcohol, such as e.g., BIOSOFT N-900 and/or BIOSOFT N91-6; C12-C15 ethoxylated alcohol such as BIOSOFT N25-3 and/or BIOSOFT N25-9; or alcohol ethoxylate/hexylene glycol surfactants such as MERPOL HCS. In embodiments, the nonionic surfactants can include high foaming nonionic surfactants, for example T-Det® A 900. In embodiments, the nonionic surfactants can include a nonionic surfactant such as BIOSOFT N25-3 or BIOSOFT N1-3 with a HLB of about 8 to 9, about 8, or about 8.7. The nonionic surfactants provide foaming action and is not added if foaming is not needed.

In embodiments, the one or more surfactants selected for a foaming composition, such as Example Composition 1 and Example Composition 2, are based on their foaming ability, cleaning ability, their ability to allow the silicone oil to deposit on a surface uniformly, and/or their ability to enable to the silicone oil not be washed when rinsed with water. An exemplary surface for testing such surfactants is the surface of a tire. As is evident when the wrong surfactant is added to the composition, the silicone oil that is deposited on the surface is easily washed off and reduces the durability of the coating provided by the composition.

The one or more silicone solvents include cyclic siloxane. Examples of cyclic siloxane includes cyclopentasiloxane (decamethylcyclopentasiloxane, D5), octamethylcyclotetrasiloxane (D4), and dodecamethylcyclohexasiloxane (D6).

The one or more silicone solvents are used in the compositions of the present disclosure to reduce the viscosity of high viscosity or high molecular weight silicone oils, for example to reduce the viscosity of the silicone oil and silicone solvent blend to 500 cSt or less.

In embodiments, each of the components of the compositions described herein can be a mixture including the main ingredient and some other ingredients such as water and other solvents. The other ingredients can also include small amounts of impurities. The other ingredients in each component can also be present in unreportable levels. For example: T Det® A 900 can include alcohol ethoxylates (about 95 wt %) as the main ingredient; BIO-SOFT N25-3 can include C12-C11 alcohol ethoxylates (about 90 wt % to 100 wt %) as the main ingredient and water (less than about 10 wt %) and other components in unreportable levels (less than about 0.1 wt %); TROYGUARD™ BC-11 can include benzothiazole-3 (2h)-one (BIT) (about 10.1 wt %) as the main ingredient, and 5-chloro-2-methyl-4-isothiazolin-3-one (CMIT) (about 0.5 wt %), and 2-methyl-2H-isothiazol-3-one (MIT) (about 0.16 wt %). Anticide® B20 can include 1,2-Benzisothiazolin-3-one (BIT) (about 20 wt %) as the main ingredient and inert ingredients (about 80 wt %). The wt % provided for each mixture is by total weight of the individual component mixture; Propellant A-46 can include Propane (about 15.2 wt %) and Isobutane (about 84.8 wt %); and Propellant A-70 can include Propane (about 42.89 wt %) and Isobutane (about 57.11 wt %).

In embodiments, optional ingredients can include fragrances, UV inhibitors, and aesthetic agents. Fragrances can include fragrance oils, perfumes, or compounds such as esters, terpenes, aromatics, amines, alcohols, and aldehydes. UV inhibitors can include chemical UV protectants, mineral UV protectants, and ceramic UV protectants. Chemical UV protectants can include UV absorbers, such as Benzophenones and benzotriazoles, and Hindered Amine Light Stabilizers (HALS)—chemical compounds that are typically derivates of tetramethylpiperidine. Some examples of HALS include Bis(2,2,6,6-tetramethyl-4-piperidinyl) sebacate and Bis(1-octyloxy-2,2,6,6-tetramethyl-4-piperidinyl) sebacate. Mineral based UV inhibitors can include metal oxides (mineral based) such as zinc oxide and titanium dioxide.

Aesthetic agents can include dyes, lustrous particles, and/or mattifying agents. Aesthetic agents can alter a visual appearance of the composition and/or a surface. For example, aesthetic agents can temporarily alter a visual appearance of the composition and/or a surface without causing damage to the surface or causing permanent visual change to the surface. In embodiments, aesthetic agents can provide color, sparkle, shine, a matte finish, or any combination thereof to the composition and/or a surface.

Dyes, for example, can include water-soluble dyes, dispersed dyes, pigment dyes, natural dyes, and/or synthetic dyes. Lustrous particles can include iridescent particles, glitter, metallic shimmer, and/or other particles that can provide sparkle aesthetic. Mattifying agents can include silica particles, such as hydrophobic modified silica particles, and/or mica. Aesthetic agents can be mineral based, such as mica, metallics, etc. Mineral based aesthetic agents may, may also function to provide UV protection to the surface by absorbing and/or blocking UV radiation from interacting with the surface. Aesthetic agents can include particles having particle size of about 20 micron or less. Particle size can be chosen based on the aperture size of a dispensing mechanism for the composition, for example a particle size that is effectively dispensed and does promote clogging.

Aesthetic agent can also include magnetic particles, such as iron oxide (Fe₃O₄), nickel, cobalt, gadolinium, terbium and erbium. In embodiments, a magnetic aesthetic agent can be included in a composition of the present disclosure. After the composition including the magnetic aesthetic agent is applied onto a target surface, a magnet can be held near the applied area to move the magnetic aesthetic agent to achieve a desired visual effect before the composition dries on the surface.

In embodiments, when the composition includes a highly crosslinked, polyacrylic acid homopolymers, such as CARBOPOL 690, a nonionic surfactant with a HLB, for example from about 7 to 9, about 8 to 9, or about 8.0. can be used for better wash durability, foaming, and dust masking. In this case, the gloss enhancer, such as silicone oil, can have a cSt of 1 to 500 cSt.

In embodiments, when the composition includes a highly crosslinked, polyacrylic acid homopolymers, such as CARBOPOL 690, a silicone solvent can be used with a gloss enhancer of greater than 500 cSt. The gloss enhancer can have a viscosity of greater than 500 cSt, when used in a mixture or blend with a silicone solvent to decrease the viscosity of the silicone oil to less than 500 cSt.

Compositions of the present disclosure can also include: deionized water, lightly crosslinked, hydrophobically modified acrylic acid copolymer, such as crosslinked copolymer of acrylic acid and C10-C30 alkyl acrylate, dimethylsiloxane ethylene oxide block copolymer, sodium nitrite, morpholine, silicone oil with viscosity of about 0.5 to 500 cSt or a blend including a silicone oil having a viscosity of between about 500 cSt to 2,000,000 cSt and a silicone solvent; and optionally: one or more preservatives; and one or more hydro carbon based propellants.

Compositions of the present disclosure can include: deionized water, lightly crosslinked, hydrophobically modified acrylic acid copolymer of acrylic acid and C10-C30 alkyl acrylate, dimethylsiloxane ethylene oxide block copolymer, sodium nitrite, morpholine, and silicone oil with a viscosity of about 100 to 500 cSt; and optionally: a high foaming surfactant, such as C9-C11 ethoxylated alcohol; preservative including BIT, MIT, and CMIT; and hydrocarbon based propellant. In embodiments, the viscosity of the silicone oil is about 350 cSt and/or the composition includes the C9-C11 ethoxylated alcohol or C12-C15 ethoxylated alcohol. Examples of such a composition include Example Composition 1 and Example Composition 2.

Compositions of the present disclosure can include: deionized water, lightly crosslinked, hydrophobically modified acrylic acid copolymer, such as crosslinked copolymer of acrylic acid and C10-C30 alkyl acrylate, dimethylsiloxane ethylene oxide block copolymer, sodium nitrite, morpholine, silicone oil with viscosity of about 700 to 15,000 cSt, and cyclopentasiloxane; and optionally: preservative including BIT, MIT, and CMIT; and hydrocarbon based propellant. In embodiments, the silicone oil has a viscosity of about 1,000 cSt. An example of such a composition includes Example Composition 3.

Compositions of the present disclosure can include: deionized water, lightly crosslinked, hydrophobically modified acrylic acid copolymer, such as crosslinked copolymer of acrylic acid and C10-C30 alkyl acrylate, dimethylsiloxane ethylene oxide block copolymer, sodium nitrite, morpholine, silicone oil with viscosity of about 700 to 15,000 cSt, and cyclopentasiloxane; and optionally: preservative including BIT, MIT, and CMIT; and hydrocarbon based propellant. In embodiments, the silicone oil has a viscosity of about 12,500 cSt. An example of such a composition includes Example Composition 4.

Composition of the present disclosure can also include: deionized water, 2-propenoic acid homopolymer, dimethylsiloxane ethylene oxide block copolymer, sodium nitrite, morpholine, nonionic surfactant having a HLB from about 7 to 9, about 8 to 9, or about 8, and silicone oil with a viscosity of about 100 to 500 cSt; and optionally: preservative including BIT, MIT, and CMIT; and hydrocarbon based propellant. In embodiments, the silicone oil comprises silicone oil with a viscosity of 350 cSt. Examples of such a composition include Example Compositions 5 or 6.

Composition of the present disclosure can also include: deionized water, 2-propenoic acid homopolymer, dimethylsiloxane ethylene oxide block copolymer, sodium nitrite, morpholine, and silicone oil with a viscosity of about 700 to 15,000 cSt; and optionally a preservative including BIT, MIT, and CMIT. In embodiments, the silicone oil comprises silicone oil with a viscosity of 1000 cSt. Examples of such a composition include Example Composition 7.

In embodiments, the composition can include, by total weight of the composition, about 60% to 98% water, about 69% to 95% water, about 60% to 75% water, or about 70% to 85% water. For example, the composition can include, by total weight of the composition, about 66.266 water, about 78.0957% water, about 82.709% water, about 88.935% water, about 78.990% water, or about 84.935% water.

In embodiments, the composition can include, by total weight of the composition, about 0.01% to 0.50% thickeners, about 0.05% to 0.50% thickeners, or about 0.05% to 0.20% thickeners. For example, the composition can include, by total weight of the composition, about 0.093% thickeners, about 0.10% thickeners, or about 0.1183% thickeners.

In embodiments, the composition can include, by total weight of the composition, about 0.05% to 1.00% wetting agents, about 0.10% to 0.50% wetting agents, or about 0.20% to 0.40% wetting agents. For example, the composition can include, by total weight of the composition, about 0.279% wetting agents, about 0.30% wetting agents, or about 0.364% wetting agents.

In embodiments, the composition can include, by total weight of the composition, about 0.05% to 1.00% corrosion inhibitors, about 0.05% to 0.50% corrosion inhibitors, or about 0.10% to 0.30% corrosion inhibitors. For example, the composition can include, by total weight of the composition, about 0.2325% corrosion inhibitors, about 0.25% corrosion inhibitors, or about 0.273% corrosion inhibitors.

In embodiments, the composition can include, by total weight of the composition, about 0.01% to 1.00% pH adjusters, about 0.05% to 0.50% pH adjusters, or about 0.10% to 0.30% pH adjusters. For example, the composition can include, by total weight of the composition, about 0.186% pH adjusters, about 0.20% pH adjusters, or about 0.273% pH adjusters.

The compositions described herein can include, by total weight of the composition, about 1.00% to 30.00% gloss enhancers, about 5.00% to 20.00% gloss enhancers, or about 8.00% to 15.00% gloss enhancers. For example, the composition can include, by total weight of the composition, about 9.10% gloss enhancers, about 9.30% gloss enhancers, about 10.00% gloss enhancers, about 13.02% gloss enhancers, or about 14.00% gloss enhancers.

The compositions described herein can include, by total weight of the composition, about 0.01% to 0.10% preservatives, about 0.02% to 0.08% preservatives, or about 0.04% to 0.06% preservatives. For example, the composition can include, by total weight of the composition, about 0.046% preservatives, about 0.0465% preservatives, or about 0.05% preservatives.

The compositions described herein can include, by total weight of the composition, about 1% to 60%, 2% to 50%, 3% to 25%, or 5.00% to 15.00% propellants. In embodiments, the amount of propellant in the composition is about 5.00% to 10.00% propellants or about 6.00% to 9.00% propellants. For example, the compositions can include, by total weight of the composition, about 6.00% propellants, about 7.00% propellants, or about 9.00% propellants.

The compositions described herein can include, by total weight of the composition, about 0.01% to 1.00% nonionic surfactants, about 0.05% to 0.50% nonionic surfactants, about 0.10% to 0.30% nonionic surfactants, or about 0.10% to 0.30% nonionic surfactants. For example, the composition can include, by total weight of the composition, about 0.165% nonionic surfactants, about 0.153% nonionic surfactants, or about 0.154% nonionic surfactants.

The compositions described herein can include, by total weight of the composition, about 1.00% to 10.00% silicone solvents, about 1.00% to 5.00% silicone solvents, about 10.00% to 20.00% silicone solvents, or about 12.00% to 15.00% silicone solvents. For example, the composition can include, by total weight of the composition, about 2.73% silicone solvents, or about 14.56% silicone solvents.

When the compositions described herein include one or more gloss enhancers, such as a silicone oil of high viscosity, for example, above 500 cSt or from about 800 cSt to 2,000,000 cSt, one or more silicone solvents, such as cyclopentasiloxane, can be added in an effective amount to obtain a preblend with a reduced viscosity that is from 0.5 cSt to 500 cSt. In embodiments, the viscosity of a preblend of the one or more gloss enhancers and one or more silicone solvents is about 100 cSt to 500 cSt, about 300 cSt to 500 cSt, about 400 cSt to 475 cSt, or about 420 cSt to 440 cSt. In embodiments, the amount of the one or more gloss enhancers in the preblend is about 0.20% to 80.00%, about 10.00% to 70.00%, about 20.00% to 60.00%, about 25.00% to 50%, or about 30.00% to 40.00% by total weight of the preblend. In embodiments, the one or more silicone solvents in the preblend is about 20.00% to 99.8%, about 30% to 90%, about 40% to 80%, or about 50% to 70% by total weight of the preblend. In embodiments, the amount of the preblend included in the composition is about 5% to 50%, about 5% to 40%, or about 5% to 30% by total weight of the composition.

In embodiments, when such a preblend is included in the composition, a surfactant such as a high foaming nonionic surfactant can be omitted.

In embodiments, when a silicone oil of about 0.5 cSt to 500 cSt is used in the compositions described herein, a silicone solvent, such as cyclopentasiloxane need not be included in the composition, but a high foaming surfactant can be included in the composition.

In embodiments, in the presence of one or more highly crosslinked poly acrylic acid homopolymers (such as CARBOPOL 690) and silicone oil of less than 500 cSt, a nonionic surfactant with a HLB of about 7 to 9, about 8 to 9, or about 8.0, such as BIOSOFT N25-3, is included in the composition.

In embodiments, other dispensing mechanisms that enables the breakdown of the polymer, such as PEMULEN 1622, PEMULEN 1621, or CARBOPOL 690, to release the silicone oil can be used for dispensing the compositions described herein. Thus, instead of aerosolization of the composition containing propellant through a spray, the composition does not need to include propellant and can be dispensed by any method that allows the dissociation of the silicone oil from the polymer and the attachment to a surface. Examples of alternative dispensing mechanisms that do not include hydrocarbon propellants include: Bag-on-Valve (BOV) technology which separates the composition from a compressed air or nitrogen propellant within the can; propellant-free systems such as twist-activated mechanisms that can dispense the composition; pump sprayers and/or mist sprayers which utilize a manual pump mechanism to dispense composition; and refillable mechanical spray bottles. Moreover, alternative methods to hydrocarbon propellants can utilize pressure to propel the composition through a valve and actuator to breakdown the polymer and allow dissociation of the silicone oil from the polymer and the attachment to a surface.

The present disclosure describes methods of preparing the compositions described herein. In embodiments, the methods can include adding water to a container and agitating the water; while agitating the water, passing one or more thickeners through a sieve with a mesh screen if required to remove clumping and adding the one or more thickeners to the water, and mixing for about 10 minutes (mins) to 90 mins, about 20 mins to 60 mins, or until the one or more thickeners are well dispersed; adding in one or more nonionic surfactants and mixing from 2 mins to 10 mins, or about 5 mins, if surfactant is required or omitting this step; adding in one or more gloss enhancers and mixing from 2 mins to 15 mins, or about 5 mins to 10 mins; adding one or more pH adjusters and mixing for about 10 mins to 30 mins, or about 15 mins to 20 minutes, to obtain a homogenous mixture; adding one or more low foaming wetting agents and mixing for about 10 mins to 20 mins, or about 15 mins; adding one or more corrosion inhibitors and mixing for about 5 mins to 25 mins, or about 10 mins to 20 mins to obtain the composition. In embodiments, the one or more nonionic surfactants may be heated, for example in a heat room at 35° C. or above and mixed for about 10 mins to about 15 mins before adding the one or more nonionic surfactants to the container.

The present disclosure describes methods of preparing the compositions presented herein. In embodiments, the methods can include adding water to a container and agitating the water; while agitating the water, passing one or more thickeners through a sieve with a mesh screen, if required to remove clumping, and adding the one or more thickeners to the water and mixing for about 30 minutes (mins) to 90 mins, about 60 mins, or until the one or more thickeners are well dispersed; forming a preblend by filling a separate container with one or more gloss enhancers and adding in one or more silicone solvents under constant mixing to adjust the viscosity of the preblend to about 400 cSt to 475 cSt or about 420 cSt to 440 cSt; adding the preblend to the mixture containing water and the one or more thickeners and mixing from 2 mins to 10 mins, or about 5 mins; adding one or more pH adjusters and mixing for about 10 mins to 30 mins, or about 20 minutes, to obtain a homogenous mixture; adding one or more low foaming wetting agents and mixing for about 10 mins to 20 mins, or about 15 mins; adding one or more corrosion inhibitors and mixing for about 5 mins to 15 mins, or about 10 mins to obtain the composition.

The methods described herein further includes adding one or more preservatives and mixing for about 2 mins to 25 mins, and optionally mixing for about 10 mins to 20 mins. In embodiments, the one or more preservatives can be added simultaneously with the one or more corrosion inhibitors.

The methods described herein further include adding one or more fragrances, UV inhibitors, and/or aesthetic agents to the composition. Fragrances can be added, for example, after the water, the one or more thickeners, the preblend, the one or more pH adjusters, the one or more low foaming wetting agents, the one or more corrosion inhibitors, or the one or more preservatives, and mixing to form a homogeneous mixture. UV inhibitors can be added, for example, after the water, the one or more thickeners, the preblend, the one or more pH adjusters, the one or more low foaming wetting agents, the one or more corrosion inhibitors, or the one or more preservatives, and mixing to form a homogeneous mixture. Aesthetic agents can be added, for example, after the water, the one or more thickeners, the preblend, the one or more pH adjusters, the one or more low foaming wetting agents, the one or more corrosion inhibitors, or the one or more preservatives, and mixing to form a homogeneous mixture. For example, dyes can be added after the water, the one or more thickeners, the preblend, the one or more pH adjusters, the one or more low foaming wetting agents, the one or more corrosion inhibitors, or the one or more preservatives, and mixing to form a homogeneous mixture. In embodiments, fragrances, UV inhibitors, and/or aesthetic agents that are hydrophobic in nature may need to be mixed with a hydrophobic material (e.g., silicone oil) to be incorporated into the system. For example, a hydrophobic fragrance, UV inhibitor, and/or aesthetic agent can be added to the one or more silicone oils prior to being added to the mixture, or the hydrophobic fragrance, UV inhibitor, and/or aesthetic agent can be added to the preblend first and then added to the mixture.

In embodiments, aesthetic agents can include particles having particle size of about 20 micron or less. Particle size can be chosen based on the aperture size of a dispensing mechanism for the composition, for example a particle size that is effectively dispensed and does promote clogging. In embodiments, the addition of particles to the composition can be adjusted and optimized to allow the integration of aesthetic components into the composition and the formation a homogeneous mixture. For example, lustrous particles, including iridescent particles, glitter, metallic shimmer, and/or other particles that can provide sparkle aesthetic, can be added after the water, the one or more thickeners, the preblend, the one or more pH adjusters, the one or more low foaming wetting agents, the one or more corrosion inhibitors, or the one or more preservatives, and mixing to form a homogeneous mixture. For example, mattifying agents, including silica particles and/or mica can be added after the water, the one or more thickeners, the preblend, the one or more pH adjusters, the one or more low foaming wetting agents, the one or more corrosion inhibitors, or the one or more preservatives, and mixing to form a homogeneous mixture. For example, magnetic particles, such as iron oxide (Fe₃O₄), nickel, cobalt, gadolinium, terbium and erbium, can be added after the water, the one or more thickeners, the preblend, the one or more pH adjusters, the one or more low foaming wetting agents, the one or more corrosion inhibitors, or the one or more preservatives, and mixing to form a homogeneous mixture. In embodiments, aesthetic agents can include particles that are hydrophobic in nature which may need to be mixed with a hydrophobic material (e.g., silicone oil) to be incorporated into the system. For example, a hydrophobic aesthetic agent, such as hydrophobically modified silica and silica particles, can be added to the one or more silicone oils prior to being added to the mixture, or the hydrophobic aesthetic agent can be added to the preblend first and then added to the mixture. In embodiments, particles added to the composition may settle over time, and the composition can be mixed (i.e. shaken, stirred, etc.) to for a suspension of the particles prior to application of the composition to a surface.

The methods described herein further includes placing the prepared composition in an aerosol can and filling the can with hydrocarbon based propellant, nitrogen propellant, or dimethyl ether propellant. Moreover, the prepared composition can be placed in any container with a dispensing mechanism that can breakdown the polymer after dispensing the composition to a surface.

The present disclosure also provides a method of providing cleaning, shine, and/or protection to a surface, wherein the method comprises applying one or more compositions described herein to the surface and allowing the surface to dry. Applying the one or more compositions include spraying the compositions described herein on the surface and the composition dries in 15 seconds to 15 minutes. For example, the composition dries within one minute. In embodiments, the composition is applied in a single step and does not require wiping.

The methods described herein can be used to clean, protect, and and/or provide shine to various surfaces including rubber surface, vinyl surface, leather surface, plastic surface, or painted surface. In embodiments, the surface can be in the exterior or interior of a vehicle. For example, the surface can be the surface of a tire or trim.

In embodiments, compositions of the present disclosure that contain one or more nonionic surfactant, such as the Example Composition 1 and Example Composition 2, can be used on uncleaned surfaces to provide a visual appearance of cleaning. Depending on the level of dirt on an uncleaned surface, coating with a composition of the present disclosure that contains one or more nonionic surfactant can provide a glossy and/or semi-glossy appearance and provides an improved look compared to untreated dirty surface. Compositions of the present disclosure that contain one or more nonionic surfactant uniquely provide a visual appearance of cleaning to an unclean surface by providing an even coating of Silicone oil on dirty surfaces within 30 mins or less.

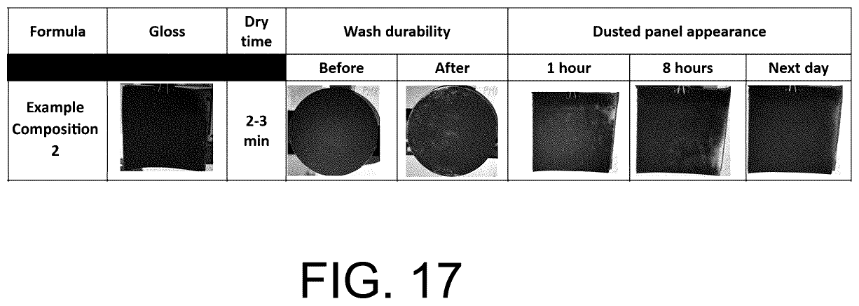

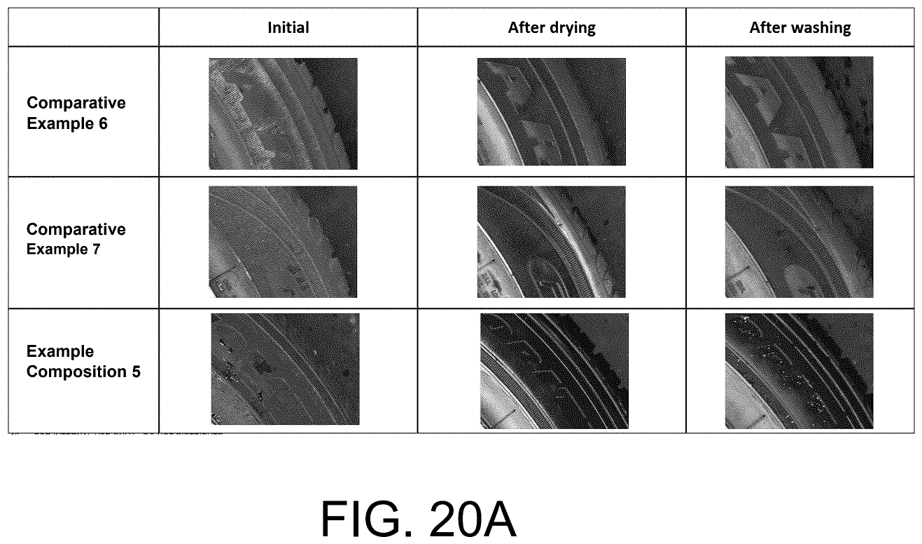

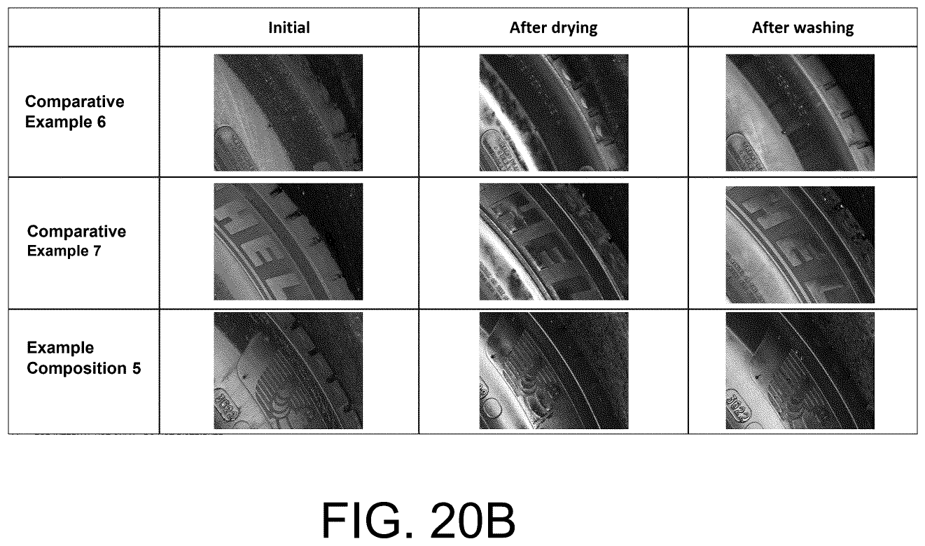

When applied to dirty surfaces, compositions that contain one or more nonionic surfactant also maintain wash durability. See FIG. 17 and FIGS. 20A and 20B. Compositions of the present disclosure provide shine and protect surfaces by providing a durable coating that protects and provides shine (gloss) to the surface even after several washes.

The methods described herein provides durable gloss to the surface even after 1 to 10 washes. Under brush car washing conditions, the durable gloss can last for 1, 2, 3, 4, or 5 washes, and under brushless car washing conditions the durable gloss can last for 4, 5, 6, 7, 8, 9, or 10 washes.

The terms “composition(s)” and “formulation(s)” are used interchangeably to refer to the compositions described herein.

The term “wt %” or “%” in the context of the weight of the component in the composition are used interchangeably to be relative to the total weight of the composition.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition, for example, for providing protection and/or shine to a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments:

1. A composition including:
(a) water;
one or more thickeners;
one or more wetting agents;
one or more corrosion inhibitors;
one or more pH adjusters; and one or more gloss enhancers having a viscosity of from about 0.5 cSt to 500 cSt, or one or more gloss enhancers having a viscosity of between about 500 cSt to 2,000,000 cSt and one or more silicone solvents; and optionally, the one or more gloss enhancers and the one or more silicone solvents are blended together to form a preblend having a viscosity of about 0.5 to 500 cSt; and optionally, one or more preservatives and/or one or more propellants; or
(b) by total weight of the composition:
about 45.00% to 95.00% water;
about 0.01% to 0.50% of one or more thickeners;
about 0.05% to 1.00% of one or more wetting agents;
about 0.05% to 1.00% of one or more corrosion inhibitors;
about 0.05 to 1.00% of one or more pH adjusters; and about 5.00% to 30.00% of one or more gloss enhancers having a viscosity of from about 0.5 to 500 cSt, or about a 5.00% to 50.00% of a preblend including about 0.20% to 80.00% of one or more gloss enhancers having a viscosity of between about 500 cSt to 2,000,000 cSt and about 20.00% to 99.80% of one or more silicone solvents, and wherein the composition includes an amount of the one or more silicone solvents that decreases the viscosity of the silicone oil to about 100 cSt to 500 cSt, about 300 cSt to about 500 cSt, or about 420 cSt to 440 cSt; and optionally, about 0.01% to 0.10% of one or more preservatives; and/or about 5.00% to 10.00% one or more hydrocarbon based propellant.

2. The composition of embodiment 1, wherein the composition includes:
(a) water; one or more thickeners; one or more wetting agents; one or more corrosion inhibitors; one or more pH adjusters; and one or more gloss enhancers having a viscosity of from about 0.5 cSt to 500 cSt; and optionally, one or more nonionic surfactants, one or more preservatives, and/or one or more propellants;
or
(b) by total weight of the composition:
about 69.00% to 95.00% water;
about 0.01% to 0.50% of one or more thickeners;
about 0.05% to 1.00% of one or more wetting agents;
about 0.05% to 1.00% of one or more corrosion inhibitors;
about 0.05 to 1.00% of one or more pH adjusters; and about 5.00% to 30.00% of one or more gloss enhancers having a viscosity of from about 0.5 cSt to 500 cSt; and optionally:
about 0.05% to 0.5% of one or more surfactants;
about 0.01% to 0.10% of one or more preservatives; and/or about 5.00% to 10.00% one or more hydrocarbon based propellant

3. The composition of embodiment 1, wherein the composition includes:
(a) water;
one or more thickeners;
one or more wetting agents;
one or more corrosion inhibitors;
one or more pH adjusters;
one or more gloss enhancers having a viscosity of between about 500 cSt to 2,000,000 cSt; and one or more silicone solvents;
and optionally, one or more preservatives and/or one or more propellants;
or
(b) by total weight of the composition:
about 70.00% to 90.00% water;
about 0.05% to 0.50% of one or more thickeners;
about 0.05% to 1.00% of one or more wetting agents;
about 0.05% to 1.00% of one or more corrosion inhibitors;
about 0.05% to 1.00% of one or more pH adjusters;
about 5.00% to 30.00% of one or more silicone oils having a viscosity of between about 500 cSt to 2,000,000 cSt; and about 1.00% to 30.00% of one or more silicone solvents; and optionally:
about 0.01% to 0.10% of one or more preservatives; and/or about 5.00% to 10.00% hydrocarbon based propellant.

4. The composition of any of embodiments 1-3, wherein the water is distilled water, deionized water, or reverse osmosis water.

5. The composition of any of embodiments 1-4, wherein the one or more thickeners include a poly(vinyl pyrrolidone/acrylic acid), acrylate polymer, acrylic acid based polymer, and acrylic-acid based copolymer.

6. The composition of any one of embodiments 1-5, wherein the one or more thickeners include a crosslinked, polyacrylic acid polymer, and optionally wherein the crosslinked polyacrylic acid polymer includes a highly crosslinked, polyacrylic acid homopolymer or crosslinked, hydrophobically modified acrylic acid copolymer; and optionally: wherein the highly crosslinked, polyacrylic acid homopolymer includes 2-propenoic acid homopolymer; or wherein the crosslinked, hydrophobically modified acrylic acid copolymer includes a moderately crosslinked, hydrophobically modified copolymer of acrylic acid and C10-C30 alkyl acrylate or a lightly crosslinked, hydrophobically modified copolymer of acrylic acid and C10-C30 alkyl acrylate.

7. The composition of any one of embodiments 1-6, wherein the one or more wetting agents include a low foaming wetting agent.

8. The composition of any one of embodiments 1-7, wherein the one or more wetting agents include a silicone polyether copolymer, and optionally wherein the silicone polyether copolymer includes dimethylsiloxane ethylene oxide block copolymer.

9. The composition of any one of embodiments 1-8, wherein the one or more corrosion inhibitors include an inorganic inhibitor and organic inhibitor, and optionally, wherein the one or more corrosion inhibitors include both a liquid phase corrosion inhibitor and a vapor phase corrosion inhibitor.

10. The composition of any one of embodiments 1-9, wherein the one or more corrosion inhibitors include a nitrite, nitrate, phosphate, chromate, and molybdate.

11. The composition of any one of embodiments 1-10, wherein the one or more corrosion inhibitors include a low-odor corrosion inhibitor (LCI), and optionally wherein the LCI includes sodium nitrite.

12. The composition of any one of embodiments 1-11, wherein the one or more corrosion inhibitors include an amino acid, alcohol, and amine, and optionally wherein the amine includes triethanolamine, dicycloheylamine, or diisopropyl amine.

13. The composition of any one of embodiments 1-12, wherein the one or more pH adjusters include a nitrogen containing pH adjusting agents.

14. The composition of any one of embodiments 1-13, wherein the one or more pH adjusters include tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine), morpholine, and morpholine derivative.

15. The composition of any one of embodiments 1-14, wherein the one or more pH adjusters include a volatile corrosion inhibitor (VCI), and optionally wherein the VCI includes morpholine or a morpholine derivative.

16. The composition of any one of embodiments 1-15, wherein the one or more preservatives include hydantoin germicide, carbamate fungicide, benzisothiazolinone (BIT), methylisothiazolinone (MIT), methylchloroisothiazolinone (CMIT), and a combination thereof.

17. The composition of any one of embodiments 1-16, wherein the one or more preservatives include a combination of BIT, MIT, and CMIT.

18. The composition of any one of embodiments 1-17, wherein the one or more propellants include a hydrocarbon based propellant, nitrogen propellant, and dimethyl ether propellant.

19. The composition of any one of embodiments 1-18, wherein the one or more propellants include a blend of propane and isobutane and having a vapor pressure of about 70 psig at about 70° F.

20. The composition of any one of embodiments 1-19, wherein the one or more gloss enhancers include one or more silicone oils.

21. The composition of any one or embodiments 1-20, wherein the one or more gloss enhancers include one or more silicone oils having a viscosity of about 1.0 to 2,000,000 centistokes (cSt), about 1 to 1,000,000 cSt, about 5 to 500,000 cSt, about 5 to 100,000 cSt, about 10 to 20,000 cSt, about 100 to 18,000 cSt, about 150 to 16,000 cSt, about 200 to 14,000 cSt, about 250 to 13,000 cSt, about 300 to 12,500 cSt, about 350 to 12,000 cSt, about 400 to 10,000 cSt, about 450 to 7,500 cSt, about 500 to 5,000 cSt, about 700 to 2,500 cSt, about 800 to 1,000 cSt, about 300 to 1,100 cSt, about 350 to 1,000 cSt, about 900 to 13,000 cSt, about 1,000 to 12,500 cSt, about 11,000 to 13,000 cSt, about 50 cSt to 500 cSt, or about 200 cSt to 400 cSt, about 350 cSt, about 1,000 cSt, or about 12,500 cSt.

22. The composition of any one of embodiments 1-21, wherein the one or more gloss enhancers include one or more silicone oils having a viscosity of about 420 cSt to 440 cst, about 350 cSt, about 1,000 cSt, or about 12,500 cSt.

23. The composition of any one of embodiments 1-22, wherein the one or more gloss enhancers include one or more silicone oils having the formula:

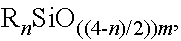

wherein:
n is 0 to 3;
m is 2 or greater; and
R is alkyl, alkylene, allyl, aryl, benzyl, phenyl, amine, amide, vinyl, fluoroalkyl, perfluoroalkane, carboxyester, or quaternary alkyl ammonium.

24. The composition of any one of embodiments 1-23, wherein the one or more gloss enhancers include one or more polyorganosiloxanes.

25. The composition of any one of embodiments 1-24, wherein the one or more gloss enhancers include a polydimethylsiloxane, polydiethylsiloxane, and polyalkylarylsiloxane.

26. The composition of any one of embodiments 1-25, further including one or more nonionic surfactants.

27. The composition of embodiments 26, wherein the one or more nonionic surfactants include a high foaming nonionic surfactant.

28. The composition of embodiments 26 or 27, wherein the one or more nonionic surfactants include an ethoxylated nonionic surfactant, and optionally the ethoxylated nonionic surfactant includes C9-C11 ethoxylated alcohol or C12-C15 ethoxylated alcohol.

29. The composition of any one of embodiments 1 and 3-24, wherein the one or more silicone solvents include one or more cyclic siloxanes, and optionally the one or more cyclic siloxanes include cyclopentasiloxane (decamethylcyclopentasiloxane, D5), octamethylcyclotetrasiloxane (D4), or D6-dodecamethylcyclohexasiloxane (D6).

30. The composition of any one of embodiments 1, 2, and 4-28 wherein the composition includes:
deionized water;
highly crosslinked, polyacrylic acid homopolymer;
dimethylsiloxane ethylene oxide block copolymer;
sodium nitrite;
morpholine; and
silicone oil with a viscosity of about 100 to 500 cSt; and
optionally:
C12-C15 ethoxylated alcohol;
preservative including BIT, MIT, and CMIT; and/or
hydrocarbon based propellant.

31. The composition of any one of embodiments 1, 2, and 4-28 wherein the composition includes:
deionized water;
lightly crosslinked, hydrophobically modified copolymer of acrylic acid and C10-C30 alkyl acrylate;
dimethylsiloxane ethylene oxide block copolymer;
sodium nitrite;
morpholine; and
silicone oil with a viscosity of about 100 to 500 cSt; and
optionally:
C9-C11 ethoxylated alcohol;
preservative including BIT, MIT, and CMIT; and/or
hydrocarbon based propellant.

32. The composition of any one of embodiments 1, 3-25, and 29, wherein the composition includes:
deionized water;
lightly crosslinked, hydrophobically modified copolymer of acrylic acid and C10-C30 alkyl acrylate;
dimethylsiloxane ethylene oxide block copolymer;
sodium nitrite;
morpholine;
silicone oil with a viscosity of about 700 to 11,000 cSt; and
cyclopentasiloxane; and
optionally:
preservative including BIT, MIT, and CMIT; and/or
hydrocarbon based propellant.

33. The composition of any one of embodiments 1, 3-25, and 29, wherein the composition includes:
deionized water;
lightly crosslinked, hydrophobically modified copolymer of acrylic acid and C10-C30 alkyl acrylate;
dimethylsiloxane ethylene oxide block copolymer;
sodium nitrite;
morpholine;
silicone oil with a viscosity of about 11,000 to 15,000 cSt; and
cyclopentasiloxane; and
optionally:
preservative including BIT, MIT, and CMIT; and/or
hydrocarbon based propellant.

34. The composition of any one of embodiments 1, 3-25 and 29, wherein the composition includes:
deionized water;
highly crosslinked, polyacrylic acid homopolymer;
dimethylsiloxane ethylene oxide block copolymer;
sodium nitrite;
morpholine;
silicone oil with a viscosity of about 700 to 11,000 cSt or about 11,000 to 15,000 cSt; and
cyclopentasiloxane; and
optionally:
preservative including BIT, MIT, and CMIT; and/or
hydrocarbon based propellant.

35. The composition of any one of embodiments 1, 2, 4-28, and 30, wherein the composition includes by total weight of the composition:
about 69.00% to 95.00% deionized water;
about 0.01% to 0.50% highly crosslinked, polyacrylic acid homopolymer;
about 0.05% to 1.00% dimethylsiloxane ethylene oxide block copolymer;
about 0.05% to 1.00% sodium nitrite;
about 0.05 to 1.00% morpholine; and
about 5.00% to 30.00% silicone oil with a viscosity of about 1 to 500 cSt; and
optionally
about 0.05% to 0.2% C12-C15 ethoxylated alcohol;
about 0.01% to 0.10% preservative including BIT, MIT, and CMIT; and/or about 5.00% to 10.00% hydrocarbon based propellant.

36. The composition of any one of embodiments 1, 2, 4-28, and 31, wherein the composition includes by total weight of the composition:
about 69.00% to 95.00% deionized water;
about 0.01% to 0.50% lightly crosslinked, hydrophobically modified copolymer of acrylic acid and C10-C30 alkyl acrylate;
about 0.05% to 1.00% dimethylsiloxane ethylene oxide block copolymer;
about 0.05% to 1.00% sodium nitrite;
about 0.05 to 1.00% morpholine; and
about 5.00% to 30.00% silicone oil with a viscosity of about 1 to 500 cSt; and
optionally
about 0.05% to 0.2% C9-C11 ethoxylated alcohol;
about 0.01% to 0.10% preservative including BIT, MIT, and CMIT; and/or
about 5.00% to 10.00% hydrocarbon based propellant.

37. The composition of any one of embodiments 1, 3-25, 29 and 32, wherein the composition includes by total weight of the composition:
about 70.00% to 85.00% deionized water;
about 0.1% to 0.50% lightly crosslinked, hydrophobically modified copolymer of acrylic acid and C10-C30 alkyl acrylate;
about 0.05% to 1.00% dimethylsiloxane ethylene oxide block copolymer;
about 0.05% to 1.00% sodium nitrite;
about 0.05% to 1.00% morpholine;
about 5.00% to 30.00% silicone oil with a viscosity of about 700 to 1,200 cSt; and
about 1.00% to 5.00% cyclopentasiloxane; and
optionally:
about 0.01% to 0.10% preservative including BIT, MIT, and CMIT; and/or
about 5.00% to 10.00% hydrocarbon based propellant.

38. The composition of any one of embodiments 1, 3-25, 29, and 33 wherein the composition includes by total weight of the composition:
about 60% to 75% deionized water;
about 0.1% to 0.50% lightly crosslinked, hydrophobically modified copolymer of acrylic acid and C10-C30 alkyl acrylate;
about 0.05% to 1.00% dimethylsiloxane ethylene oxide block copolymer;
about 0.05% to 1.00% sodium nitrite;
about 0.05% to 1.00% morpholine;
about 5.00% to 30.00% silicone oil with a viscosity of about 11,000 to 15,000 cSt; and
about 10.00% to 20.00% cyclopentasiloxane; and
optionally:
about 0.01% to 0.10% preservative including BIT, MIT, and CMIT; and
about 5.00% to 10.00% hydrocarbon based propellant.

39. The composition of any one of embodiments 1, 3-25, 29, and 34 wherein the composition includes by total weight of the composition:
(a) about 75% to 95% deionized water;
   about 0.01% to 0.50% highly crosslinked, polyacrylic acid homopolymer;
   about 0.05% to 1.00% dimethylsiloxane ethylene oxide block copolymer;
   about 0.05% to 1.00% sodium nitrite;
   about 0.05% to 1.00% morpholine;
   about 5.00% to 30.00% silicone oil with a viscosity of about 700 to 1,200 cSt or about 11,000 to 15,000 cSt;
   about 0.01% to 5.00% cyclopentasiloxane; and
   about 0.01% to 0.10% preservative including BIT, MIT, and CMIT;
(b) about 70.00% to 85.00% deionized water;
   about 0.1% to 0.50% highly crosslinked, polyacrylic acid homopolymer;
   about 0.05% to 1.00% dimethylsiloxane ethylene oxide block copolymer;
   about 0.05% to 1.00% sodium nitrite;
   about 0.05% to 1.00% morpholine;
   about 5.00% to 30.00% silicone oil with a viscosity of about 700 to 1,200 cSt; and
   about 1.00% to 5.00% cyclopentasiloxane; and
   optionally:
   about 0.01% to 0.10% preservative including BIT, MIT, and CMIT; and/or
   about 5.00% to 10.00% hydrocarbon based propellant; or
(c) about 60% to 75% deionized water;
   about 0.1% to 0.50% highly crosslinked, polyacrylic acid homopolymer;
   about 0.05% to 1.00% dimethylsiloxane ethylene oxide block copolymer;
   about 0.05% to 1.00% sodium nitrite;
   about 0.05% to 1.00% morpholine;
   about 5.00% to 30.00% silicone oil with a viscosity of about 11,000 to 15,000 cSt; and
   about 10.00% to 20.00% cyclopentasiloxane; and
   optionally:
   about 0.01% to 0.10% preservative including BIT, MIT, and CMIT; and about 5.00% to 10.00% hydrocarbon based propellant.

40. The composition of any one of embodiments 1, 2, 4-28, 30, and 35, wherein the composition includes by total weight of the composition:
(a) about 84.935% deionized water;
   about 0.10% highly crosslinked, polyacrylic acid homopolymer;
   about 0.30% dimethylsiloxane ethylene oxide block copolymer;
   about 0.25% sodium nitrite;
   about 0.20% morpholine;
   about 10.00% silicone oil with a viscosity of about 350 cSt; about 0.165% C12-C15 ethoxylated alcohol; and about 0.05% preservative including BIT, MIT, and CMIT; or
(b) about 78.9896% deionized water;
   about 0.093% highly crosslinked, polyacrylic acid homopolymer;
   about 0.279% dimethylsiloxane ethylene oxide block copolymer;
   about 0.2325% sodium nitrite;
   about 0.186% morpholine;
   about 13.02% silicone oil with a viscosity of about 350 cSt;
   about 0.1534% C12-C15 ethoxylated alcohol;
   about 0.046% preservative including BIT, MIT, and CMIT; and
   about 7.00% propellant comprising a blend of propane and isobutane and having a vapor pressure of about 70 psig at about 70° F.

41. The composition of any one of embodiments 1-2, 4-28, 30, and 35, wherein the composition includes by total weight of the composition:
about 78.98955% deionized water;
about 0.093% highly crosslinked, polyacrylic acid homopolymer;
about 0.279% dimethylsiloxane ethylene oxide block copolymer;
about 0.2325% sodium nitrite;
about 0.186% morpholine;
about 13.02% silicone oil with a viscosity of about 350 cSt;
about 0.15345% C12-C15 ethoxylated alcohol;
about 0.0465% preservative including BIT, MIT, and CMIT; and about 7.00% propellant including a blend of propane and isobutane and having a vapor pressure of about 70 psig at about 70° F.

42. The composition of any one of embodiments 1, 2, 4-28, 31, and 36, wherein the composition includes by total weight of the composition:
about 88.935% deionized water;
about 0.10% lightly crosslinked, hydrophobically modified copolymer of acrylic acid and C10-C30 alkyl acrylate;
about 0.30% dimethylsiloxane ethylene oxide block copolymer;
about 0.25% sodium nitrite;
about 0.20% morpholine;
about 10.00% silicone oil with a viscosity of about 350 cSt;
about 0.165% C9-C11 ethoxylated alcohol; and about 0.05% preservative including BIT, MIT, and CMIT.

43. The composition of any one of embodiments 1, 2, 4-28, 31, and 36, wherein the composition includes by total weight of the composition:
about 82.709% deionized water;
about 0.093% lightly crosslinked, hydrophobically modified copolymer of acrylic acid and C10-C30 alkyl acrylate;
about 0.279% dimethylsiloxane ethylene oxide block copolymer;
about 0.2325% sodium nitrite;
about 0.186% morpholine;
about 9.30% silicone oil with a viscosity of about 350 cSt;
about 0.153% C9-C11 ethoxylated alcohol;
about 0.0465% preservative including BIT, MIT, and CMIT; and
about 7.00% propellant including a blend of propane and isobutane and having a vapor pressure of about 70 psig at about 70° F. or about 46 psig at about 70° F.

44. The composition of any one of embodiments 1, 3-25, 29, 32, and 37, wherein the composition includes by total weight of the composition:
about 78.0957% deionized water;
about 0.1183% lightly crosslinked, hydrophobically modified copolymer of acrylic acid and C10-C30 alkyl acrylate;
about 0.364% dimethylsiloxane ethylene oxide block copolymer;
about 0.273% sodium nitrite;
about 0.273% morpholine;
about 9.1% silicone oil with a viscosity of about 1,000 cSt;
about 2.73% cyclopentasiloxane;
about 0.046% preservative including BIT, MIT, and CMIT; and
about 9.00% propellant including a blend of propane and isobutane and having a vapor pressure of about 70 psig at about 70° F.

45. The composition of any one of embodiments 1, 3-25, 29, 33, and 38 wherein the composition includes by total weight of the composition:
about 66.266% deionized water;
about 0.1183% lightly crosslinked, hydrophobically modified copolymer of acrylic acid and C10-C30 alkyl acrylate;
about 0.364% dimethylsiloxane ethylene oxide block copolymer;
about 0.273% sodium nitrite;
about 0.273% morpholine;
about 9.1% silicone oil with a viscosity of about 12,500 cSt;
about 14.56% cyclopentasiloxane;
about 0.046% preservative including BIT, MIT, and CMIT; and
about 9.00% propellant including a blend of propane and isobutane and having a vapor pressure of about 70 psig at about 70° F.

46. The composition of any one of embodiments 1, 3-25, 29, 34, and 39 wherein the composition includes by total weight of the composition:
(a) about 85.82% deionized water;
   about 0.13% highly crosslinked, polyacrylic acid homopolymer;
   about 0.4% dimethylsiloxane ethylene oxide block copolymer;
   about 0.3% sodium nitrite;
   about 0.3% morpholine;
   about 10.0% silicone oil with a viscosity of about 1,000 cSt; about 3.0% cyclopentasiloxane; and about 0.05% preservative including BIT, MIT, and CMIT; or
(b) about 78.0962% deionized water;
   about 0.1183% highly crosslinked, polyacrylic acid homopolymer;
   about 0.364% dimethylsiloxane ethylene oxide block copolymer;
   about 0.273% sodium nitrite;
   about 0.273% morpholine;
   about 9.1% silicone oil with a viscosity of about 1,000 cSt;
   about 2.73% cyclopentasiloxane;
   about 0.0455% preservative comprising BIT, MIT, and CMIT; and
   about 9.00% propellant comprising a blend of propane and isobutane and having a vapor pressure of about 70 psig at about 70° F.

47. The composition of any one of embodiments 1-46, wherein the composition further includes fragrance, one or more ultraviolet (UV) inhibitors, one or more aesthetic agents, or a combination thereof.

48. The composition of embodiment 47, wherein the one or more aesthetic agents include a dye, a lustrous particle, a mattifying agent, a magnetic particle, or a combination thereof.

49. A method of preparing the composition of any one of embodiments 1-2, 4-28, 30, 31, 35, 36, and 40-43, wherein the method includes (a) adding water to a container and agitating the water; (b) while agitating the water, adding the one or more thickeners to the water and mixing until the one or more thickeners are dispersed, and optionally passing the one or more thickeners through a sieve before adding to the water; (c) adding one or more gloss enhancers and mix; (d) adding one or more pH adjusters and mix to obtain a homogeneous mixture; (e) adding one or more wetting agents and mix; and (f) adding one or more corrosion inhibitors.

50. The method of embodiment 49, wherein the method further includes after step (b), adding one or more nonionic surfactants and mixing before adding the one or more gloss enhancers.

51. A method of preparing the composition of any one of embodiments 1, 3-25, 29, 32-34, 37-39, and 44-46, wherein the method includes (a) adding water to a container and agitating the water; (b) while agitating the water, adding the one or more thickeners to the water and mixing until the one or more thickeners are dispersed to obtain a mixture, and optionally passing the one or more thickeners through a sieve before adding to the water; (c) forming a preblend by filling a separate container with one or more gloss enhancers and adding in one or more silicone solvents under constant mixing to adjust the viscosity of the preblend; (d) adding the preblend to the mixture containing the water and the one or more thickeners; (e) adding one or more pH adjusters and mix to obtain a homogeneous mixture; (f) adding one or more wetting agents and mix; and (g) adding one or more corrosion inhibitors.

52. The method of embodiment 51, wherein the method includes adjusting the viscosity of the gloss enhancer silicone solvent preblend to about 420 cSt to 440 cSt.

53. The method of any one of embodiments 49-52, wherein the method further includes adding one or more preservatives.

54. The method of any one of embodiments 49-53, wherein the method further includes adding fragrance, one or more ultraviolet (UV) inhibitors, one or more aesthetic agents, or a combination thereof.

55. The method of embodiment 54, wherein the one or more aesthetic agents include a dye, a lustrous particle, a mattifying agent, a magnetic particle, or a combination thereof.

56. The method of embodiment 54 or 55, wherein one or more aesthetic agents are added to the one or more gloss enhancers and mixed prior to being added to the mixture and/or one or more aesthetic agents are added to the preblend and mixed prior to being added to the mixture.

57. The method of any one of embodiments 49-56, wherein the method further includes placing the prepared composition in an aerosol can and filling the aerosol can with hydrocarbon based propellant, nitrogen propellant, or dimethyl ether propellant.

58. A method of providing shine and/or durable protection to a surface, wherein the method includes applying the composition of any one of embodiments 1-48 to the surface and allowing the surface to dry, and optionally the method includes cleaning the surface when the composition includes a nonionic surfactant.

59. The method of embodiment 58, wherein applying the composition includes spraying the composition on the surface and wherein the composition dries in about 30 seconds to 15 minutes, and optionally, wherein the composition dries within one minute.

60. The method of embodiment 58 or 59 wherein the surface is a rubber surface, vinyl surface, leather surface, plastic surface, or painted surface.

61. The method of any one of embodiments 58-60, wherein the surface is a tire or trim.

62. The method of any one of embodiments 58-61, wherein the method provides durable gloss to the surface even after about 1 to 10 washes.

63. The method of any one of embodiments 58-62, when the composition is applied in a single step and does not require wiping.

### EXAMPLES

Representative embodiments of the present disclosure will now be described with reference to the following examples that illustrate the principles and practice of the present disclosure.

### Experimental Example 1

Experimental Example 1 provides a comparison of tire shine compositions currently on the market (Comparative Example 1 and Comparative Example 3), a modified version of the Comparative Example 1 (Comparative Example 2) which includes the same composition as Comparative Example 1 but with reduced amounts of wash-durability affecting components T-Det® A 900, ACUSOL 801S, and ELKAY AG 177, and a novel tire shine composition (Example Composition 1) according to one embodiment of the present disclosure. The novel tire shine composition (Example Composition 1) of Experimental Example 1 is given in Table 1.

TABLE 1
Composition of Example Composition 1

| | | Component Quantity |
|---|---|---|
| | | wt % (by total |
| | | weight of the |
| Component | Function | composition) |
| DI Water | Diluent | 82.709 |
| T-Det ® A 900 | High Foaming Surfactant | 0.153 |
| Morpholine | Neutralizer, VCI | 0.186 |
| PEMULEN 1622 | Thickener | 0.093 |
| Silicone 350 cSt | Gloss Enhancer | 9.300 |
| ELKAY 7302 | Low Foaming Wetting Agent | 0.279 |
| Sodium Nitrite | LCI | 0.2325 |
| TROYGUARD ™ BC-11 | Preservative | 0.0465 |
| Propellant A-46 | Propellant | 7.000 |
| Total | | 100.00 |

The composition of Example Composition 1 was prepared by (a) adding the water to a container and agitating the water; (b) while agitating the water, passing the PEMULEN 1622 powder through a sieve with a mesh screen and adding the PEMULEN 1622 to the water, and mixing for about 60 mins (i.e., until the PEMULEN 1622 powder was well dispersed); (c) adding in the T-Det® A 900 and mixing for about 5 mins; (d) adding in the Silicone 350 cSt and mixing for about 5 mins; (e) adding the Morpholine and mixing for about 20 minutes, to obtain a homogenous mixture; (f) adding the ELKAY 7302 and mixing for about 15 mins; (g) adding the Sodium Nitrite and mixing for about 10 mins; (h) and adding in the TROYGUARD™ BC-11 and mixing for about 10 mins, to obtain the composition. The composition was then transferred to an aerosol can and the Propellant A-46 was added to the can.

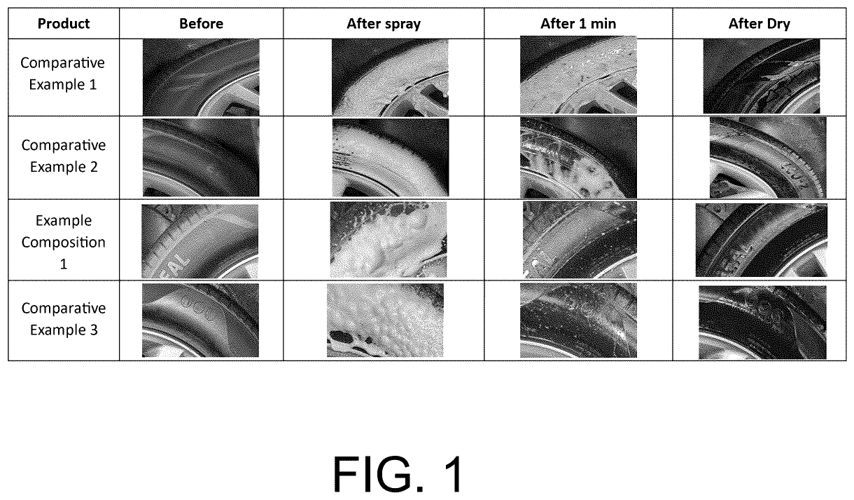

FIG. 1 shows foam flow down observations on tires for current compositions on the market (Comparative Example 1 and Comparative Example 3), a modified composition of Comparative Example 1 with reduced amounts of wash durability affecting chemicals (T-Det® A 900, ACUSOL 801S, and ELKAY AG 177) (Comparative Example 2) and an exemplary composition of the present disclosure (Example Composition 1). FIG. 1 shows the tire condition before application of the composition, the tire after spraying the composition onto the tire, the tire and composition after sitting for 1 minute, and the tire after the composition was fully dried.

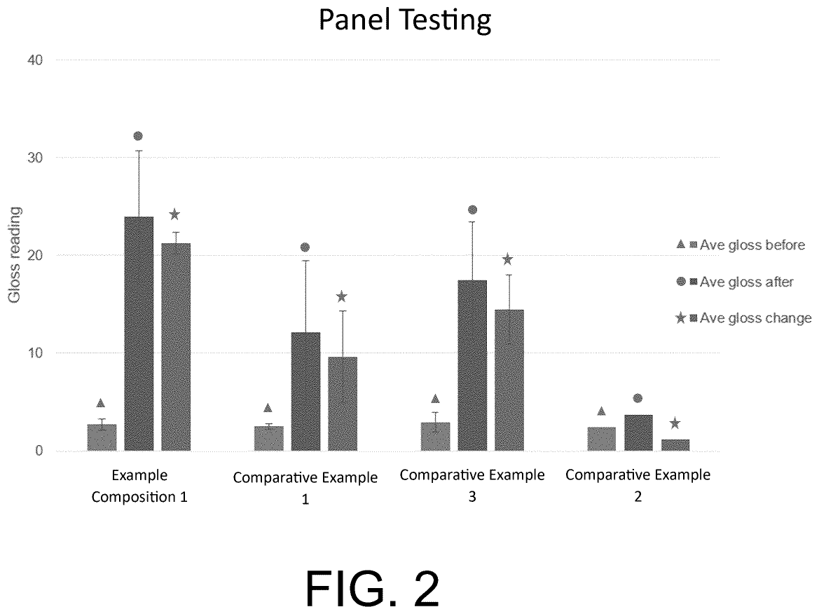

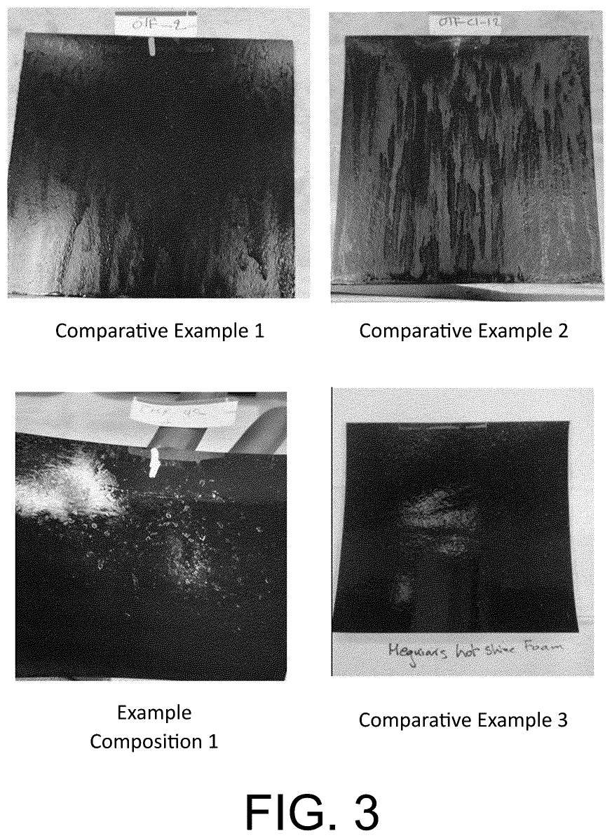

FIG. 2 shows analysis of the gloss reading for each composition tested in experimental example 1. The method for testing the gloss reading was a panel test (SBR (Styrene Butadiene Rubber)). Comparative Example 1, Comparative Example 2, Example Composition 1, and Comparative Example 3 were tested. 2-3.5 grams (aerosol) of product was applied on a 5″×5″ SBR panel hung vertically and sprayed from 6″ from the surface. The surface was allowed to dry for 1 hour and gloss is measured using Rhopoint gloss meter. FIG. 3 shows observation images of the SBR panels measured in FIG. 2 after each composition was sprayed and dried.

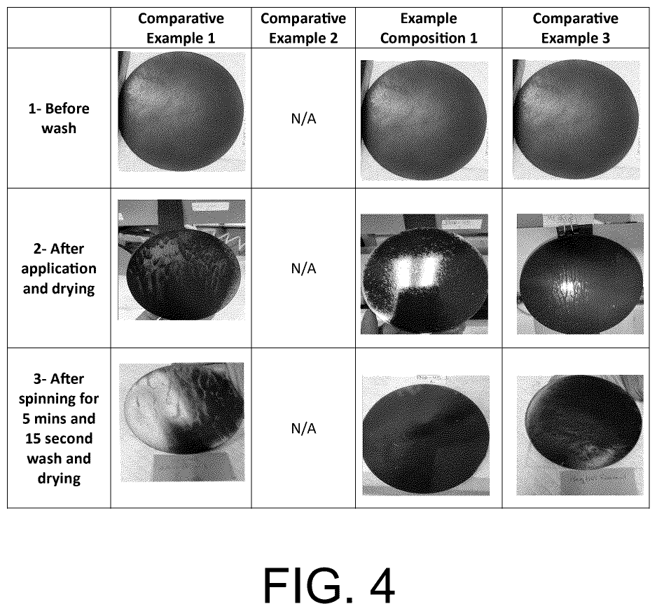

FIG. 4 shows observational images of gloss and wash durability on SBR surfaces. The results are detailed below in Table 2A.

TABLE 2A
Product Analysis-Gloss and Wash durability on SBR Observations

| | Comparative | Comparative | Example | Comparative |
|---|---|---|---|---|
| Product Name: | Example 1 | Example 2 | Composition 1 | Example 3 |
| Amount | 2.6 | 2.32 | 2.75 | 2.2 |
| sprayed (g) | | | | |
| Appearance | Low level gloss | Medium gloss, | High gloss, even | Glossy streaky |
| after drying | with streaking | very streaky and | and uniform | |
| | and poor | uneven | | |
| | coverage | | | |
| Appearance | Streaks still | Results were | High level gloss | Glossy, streaks |
| after spinning | present | very poor after | with some spots | leveled up |
| | | spraying, so | and streaks | |
| | | further testing | | |
| | | wasn't done | | |
| Appearance | Low durability, | Results were | High durability, | Medium |
| after 15 sec | low gloss | very poor after | glossy | durability, some |
| wash under tap | | spraying, so | | wash off |
| water | | further testing | | |
| | | wasn't done. | | |

In Experimental Example 1, the improved composition (Example Composition 1) was shown to be cost neutral compared to current product on the market. Therefore, the improved composition provides superior results at the same price point. Experimental Example 1 also shows through the performance of Comparative Example 2, that simply reducing the amount of the wash durability affecting chemicals (T-Det® A 900, ACUSOL 801S, and ELKAY AG 177) does not significantly improve the drying time and durability of the composition over products currently on the market.

### Experimental Example 2

As shown above, Example Composition 1 was found to be the best composition of Experimental Example 1, offering unexpected superior results compared to current compositions on the market. Experimental Example 2 presents an additional improved composition. It was unexpectedly discovered that changing the Propellant of Example Composition 1 to propellant A-70, the foam quality was improved. The improvement included a more stable foam and the foam drain from the treated surface was advantageously slowed. The novel tire shine composition (Example Composition 2 is given in Table 2B.

TABLE 2B
Composition of Example Composition 2

| | | Component Quantity |
|---|---|---|
| | | wt % (by total |
| | | weight of the |
| Component | Function | composition) |
| DI Water | Diluent | 82.709 |
| T-Det ® A 900 | High Foaming Surfactant | 0.153 |
| Morpholine | Neutralizer, VCI | 0.186 |
| PEMULEN 1622 | Thickener | 0.093 |
| Silicone 350 cSt | Gloss Enhancer | 9.300 |
| ELKAY 7302 | Low Foaming Wetting Agent | 0.279 |
| Sodium Nitrite | LCI | 0.2325 |
| TROYGUARD ™ BC-11 | Preservative | 0.0465 |
| Propellant A-70 | Propellant | 7.000 |
| Total | | 100.00 |

The composition of Example Composition 2 was prepared by (a) adding the water to a container and agitating the water; (b) while agitating the water, passing the PEMULEN 1622 powder through a sieve with a mesh screen and adding the PEMULEN 1622 to the water, and mixing for about 60 mins (i.e., until the PEMULEN 1622 powder was well dispersed); (c) adding in the T-Det® A 900 and mixing for about 5 mins; (d) adding in the Silicone 350 cSt and mixing for about 5 mins; (e) adding the Morpholine and mixing for about 20 minutes, to obtain a homogenous mixture; (f) adding the ELKAY 7302 and mixing for about 15 mins; (g) adding the Sodium Nitrite and mixing for about 10 mins; (h) and adding in the TROYGUARD™ BC-11 and mixing for about 10 mins, to obtain the composition. The composition was then transferred to an aerosol can and the Propellant A-70 was added to the can.

The improved composition of Experimental Example 2 was shown to be cost neutral compared to current product on the market. Therefore, the improved composition provides superior results at the same price point.

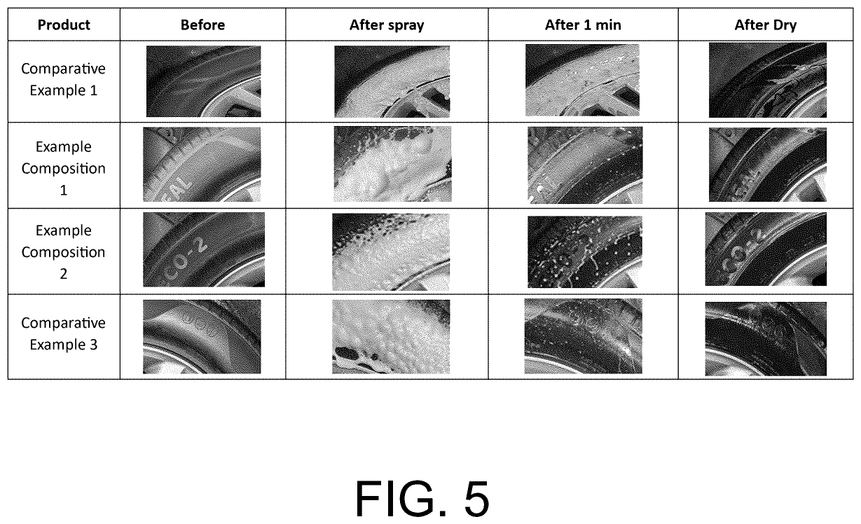

FIG. 5 shows foam flow down observations on tires for current compositions on the market (Comparative Example 1 and Comparative Example 3) and exemplary compositions of the present disclosure (Example Composition 1 and Example Composition 2). FIG. 5 shows the tire condition before application of the composition, the tire after spraying the composition onto the tire, the tire and composition after sitting for 1 minute, and the tire after the composition was fully dried.

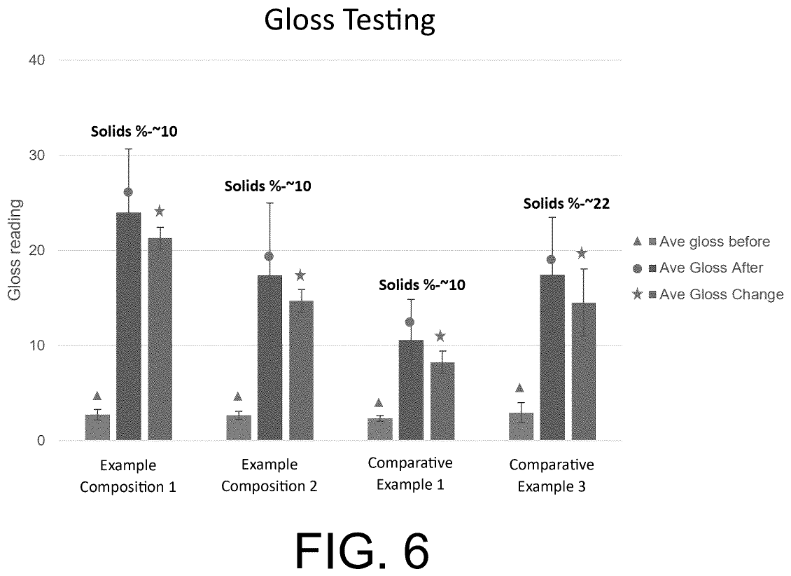

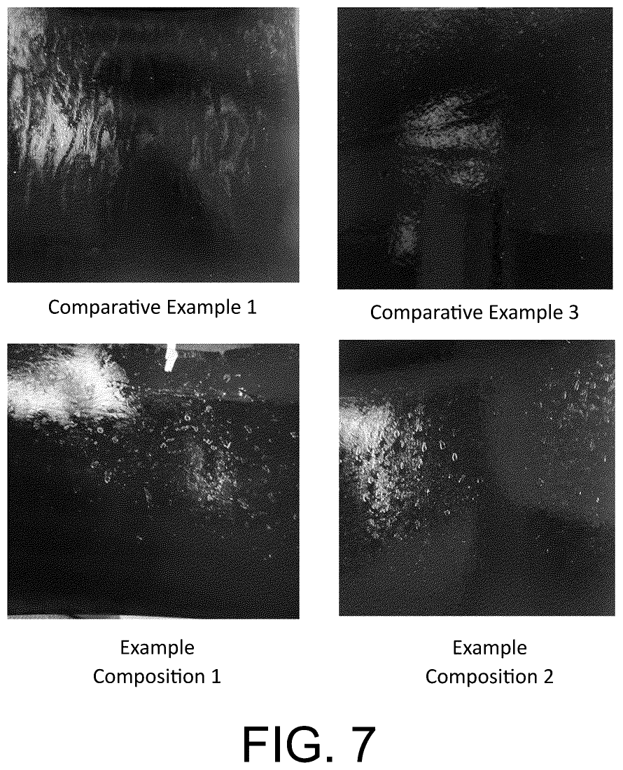

FIG. 6 shows analysis of the gloss reading for each composition tested in experimental example 2. The method for testing the gloss reading was a panel test (SBR). Comparative Example 1, Example Composition 1, Example Composition 2, and Comparative Example 3 were tested. 2-3.5 grams (aerosol) of product is applied on a 5″×5″ SBR panel hung vertically and sprayed from 6″ from the surface. The surface is allowed to dry for 1 hour and gloss was measured using Rhopoint gloss meter. Note: This data is the average of two panels per sample. Solids in Comparative Example 3 were shown to be higher (~22%) than solids in Example Composition 1, Example Composition 2, and Comparative Example 1 (~10%). FIG. 7 shows observation images of the SBR panels measured in FIG. 6 after each composition was sprayed and dried.

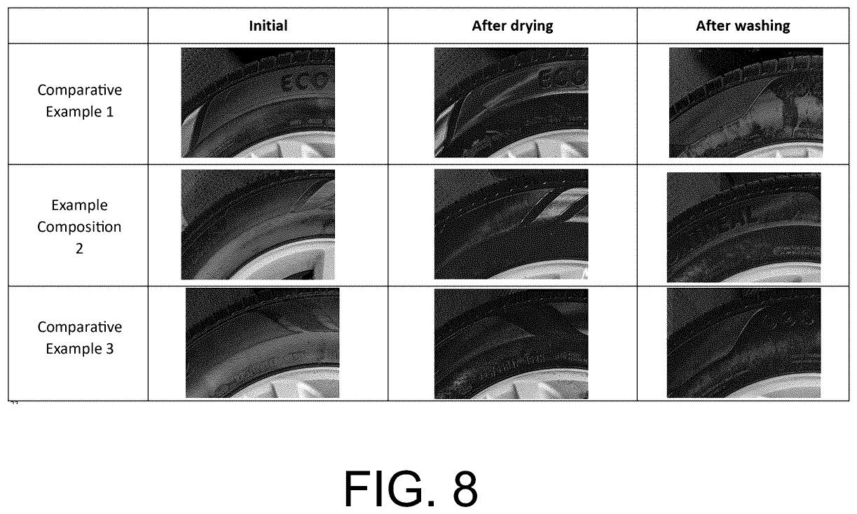

FIG. 8 shows observation images of wash durability of compositions currently on the market (Comparative Example 1 and Comparative Example 3) and an exemplary composition of the present disclosure (Example Composition 2). The images show a tire prior to application of the composition, the tire after the composition has been applied and dried, and the tire after performing a brush car wash.

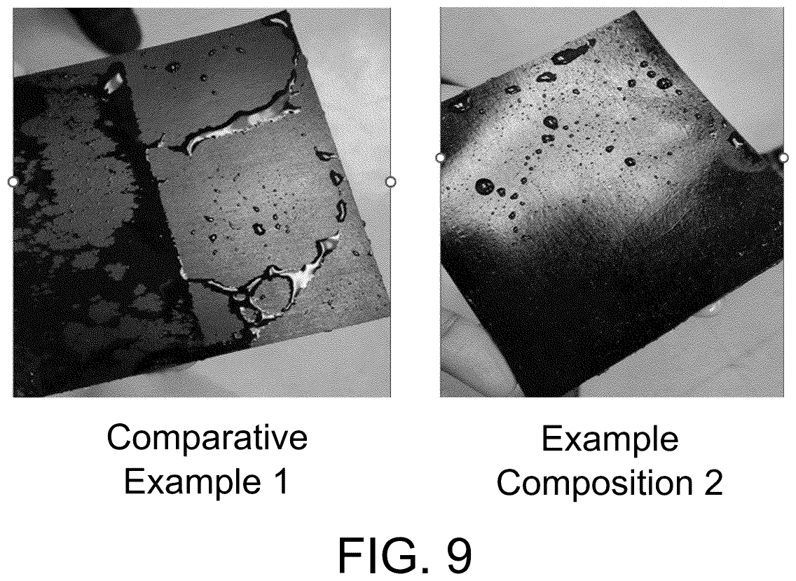

FIG. 9 shows the improved deposition and drying time of Example Composition 2 compared to a product currently on the market (Comparative Example 1). The surface was sprayed with the indicated composition, the composition was allowed to sit for 15 seconds, and then the composition was rinsed off with water. The image was taken immediately after rinsing. Example Composition 2 shows the application of greater gloss and shine to the surface compared to Comparative Example 1 after just 15 seconds.

### Experimental Example 3

Current compositions on the market have medium durability under wash and rinse conditions and may not be good enough to achieve multiple weeks of durability that consumers desire. The low molecular weight silicone that is used in these compositions is easier to wash off than high molecular weight silicone. Additionally, the ACUSOL 801S (thickener) forms a network like structure with silicone oil and the wetting agent, which dries on the tire after it's applied. When this dried coating is rehydrated, ACUSOL being water loving, pulls out the ingredients stuck in the network like structure and resolubilizes in water, leading to wash off the silicone oil.

The present disclosure solves this problem by providing methods and compositions for replacing low molecular weight silicone with high molecular weight silicone, for example Silicone 1,000 cSt or higher. Methods include replacing the thickener ingredient ACUSOL 801S with PEMULEN 1621. Unlike ACUSOL, silicone oil adsorbs onto the gel like structure of PEMULEN 1621. Silicone oil has low affinity towards the structure of PEMULEN 1621 and as soon as the product is applied to the tire, silicone oil releases from PEMULEN 1621 to the tire as the oil has a higher affinity towards the tire. The PEMULEN 1621 structure also breaks down when it is sheared by the actuator of the aerosol can application device, allowing oil release. So the oil and the wetting agent dry off on the tire, giving it higher wash resistance. It was observed that breakdown from shearing by the actuator of the aerosol can application device does not occur with ACUSOL, which is much more shear stable than PEMULEN.

The exemplary composition of Experimental Example 3 (Example Composition 3) was formulated with the PEMULEN 1621 thickener and with high molecular weight silicone, Silicone 1,000 cSt. Cyclopentasiloxane is added to the composition to help with the spreading of Silicone 1,000 cSt on tires as well as to reduce the viscosity of Silicone 1,000 cSt, which makes it easier to disperse it in the bulk phase. The composition of Experimental Example 3 was shown to be cost neutral. The composition Experimental Example 3 is given in Table 3A.

TABLE 3A
Composition of Example Composition 3

| | | Component Quantity |
|---|---|---|
| | | wt % (by total |
| | | weight of the |
| Component | Function | composition) |
| DI Water | Diluent | 78.0957 |
| PEMULEN 1621 | Thickener | 0.1183 |
| Silicone 1000 cSt | Gloss enhancer | 9.100 |
| Cyclopentasiloxane | Silicone solvent | 2.730 |
| ELKAY 7302 | Low Foaming Wetting Agent | 0.364 |
| Morpholine | Alkaline Neutralizer, VCI | 0.273 |
| Sodium Nitrite | LCI | 0.273 |
| TROYGUARD ™ BC-11 | Preservative | 0.046 |
| Propellant A-70 | Propellant | 9.000 |
| Total | | 100.00 |

The composition of Example Composition 3 was prepared by (a) adding the water to a container and agitating the water; (b) while agitating the water, passing the PEMULEN 1621 powder through a sieve with a mesh screen and adding the PEMULEN 1621 to the water, and mixing for about 60 mins (i.e., until the PEMULEN 1621 powder was well dispersed); (c) forming a preblend by filling a container with the Silicone 1000 cSt and adding in the Cyclopentasiloxane under constant mixing to adjust the viscosity of the preblend to about 400 cSt to 475 cSt; (d) adding the preblend to the mixture containing water and the PEMULEN 1621 and mixing for about 5 mins; (e) adding the Morpholine and mixing for about 20 minutes, to obtain a homogenous mixture; (f) adding the ELKAY 7302 and mixing for about 15 mins; (g) adding the Sodium Nitrite and mixing for about 10 mins; (h) and adding in the TROYGUARD™ BC-11 and mixing for about 10 mins, to obtain the composition. The composition was then transferred to an aerosol can and the Propellant A-70 was added to the can.

In accordance with embodiments of Experimental Example 3, alternatives ingredients can be used in the composition of Example Composition 3 as discussed herein. The thickener can be either PEMULEN 1621 or PEMULEN 1622. In embodiments, PEMULEN 1621 is used and the PEMULEN is the ingredient that allows oil emulsification and suspension.

The silicone oil can be Silicone 1,000 cSt, Silicone 12,500 cSt or any high molecular weight silicone oil greater than about 1,000 cSt. What matters in this experimental example is the preblend of silicone oil and cyclopentasiloxane has a viscosity of about 400-500 cSt at 25° C. In this Experimental Example, at least 8 wt. % total of the silicone oil and cyclopentasiloxane preblend in the composition can ensure good durability. It was shown that concentrations of the silicone oil and cyclopentasiloxane preblend higher than 8 wt. % provide durable compositions. It was shown that at concentrations of the silicone oil and cyclopentasiloxane preblend lower than 8 wt. %, durability was negatively affected.

The low foaming wetting agent (ELKAY 7302) is a silicone polyether copolymer surfactant. It is noted that other brands and compositions of silicone polyether copolymer surfactant can also be used in compositions of this disclosure.

Morpholine is a vapor phase corrosion inhibitor as well as a neutralizer for PEMULEN polymer. Usually, any amines can be used as long as they have low enough vapor pressure to volatilize and coat the inner linings of the aerosol cans. In the present Experimental Example, the pH would need to be raised to 7-10 for the product to work as a vapor phase corrosion inhibitor, and PEMULEN neutralizes at a pH of 5 and above.

Sodium nitrite is a liquid phase corrosion inhibitor (LCI) which protects the aerosol can from corroding where water is in contact. In this Experimental Example, the sodium nitrate works at a pH of 7.5-9. It is noted that other known corrosion inhibiters may be used instead of, or in combination with sodium nitrite to achieve the desired result. If the corrosion inhibition and pH adjustment are not needed, the corrosion inhibitor may be an optional ingredient.

TROYGUARD is a preservative, and it is noted that any preservative can be used in compositions of the present disclosure.

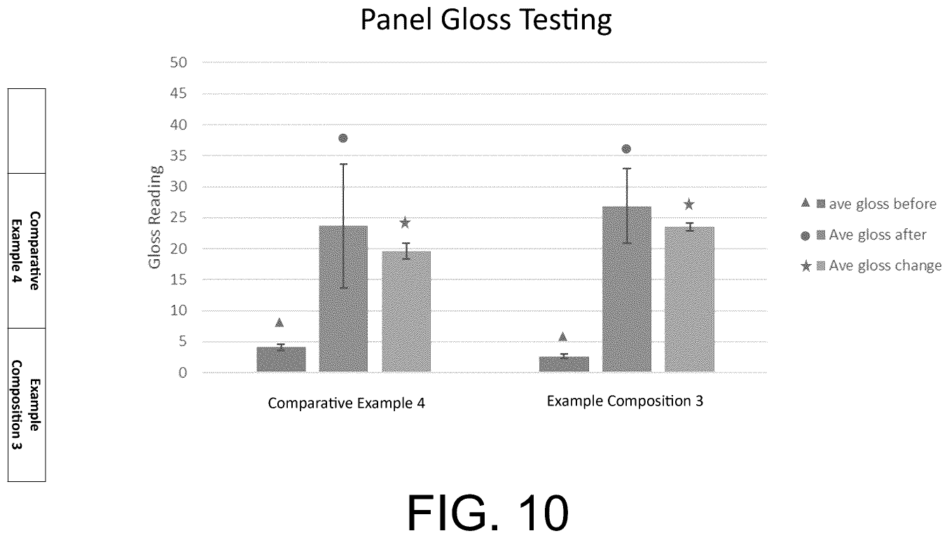

FIG. 10 shows analysis of the gloss reading for each composition tested in experimental example 3. The method for testing the gloss reading was a panel test (SBR). A prior tire shine composition (Comparative Example 4) and the composition of Experimental Example 3 (Example Composition 3) were tested for Gloss. 2-2.5 grams (aerosol) of product was applied on a 5″×5″ SBR panel hung vertically and sprayed from 6″ from the surface. The surface is allowed to dry for 1 hour and gloss was measured using Rhopoint gloss meter. It is shown that, based on numerical data, the composition of Experimental Example 3 (Example Composition 3) has slightly better gloss compared to Comparative Example 4. Comparative Example 4 seems to leave a webby like coating on the panels, but the Example Composition 3 composition seems to have uniform even coating. Note: the data of FIG. 10 is the average of two panels per sample.

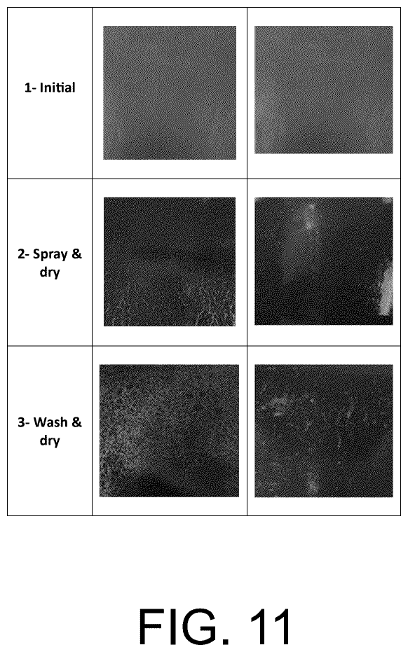

FIG. 11 shows SBR observational images of the gloss and wash durability for each composition tested in experimental example 3. The results are described below in Table 3B.

TABLE 3B
Product Analysis-Gloss and Wash durability on SBR Observations

| Product Name | Comparative Example 4 | | Example Composition 3 | |
|---|---|---|---|---|
| sample # | 1 | 2 | 1 | 2 |
| Amount of | 2.5 | 2.3 | 2.5 | 2.5 |
| sprayed (g)* | | | | |
| Appearance | light foam sits on the panel, | | light foam, defoams faster | |
| after spraying | defoams very slow, doesn't run | | than Comparative Example | |
| | down, dries on the surface leaves | | 4 leaving droplets behind | |
| | behind a webby surface | | | |
| Appearance | webby, glossy | | minimal streaks, glossy | |
| after drying | | | | |
| Appearance | low- medium durability, | | smooth & glossy, high | |
| after 180 sec | gloss reduced some | | durability | |
| wash under | wash off | | | |
| tap water | | | | |

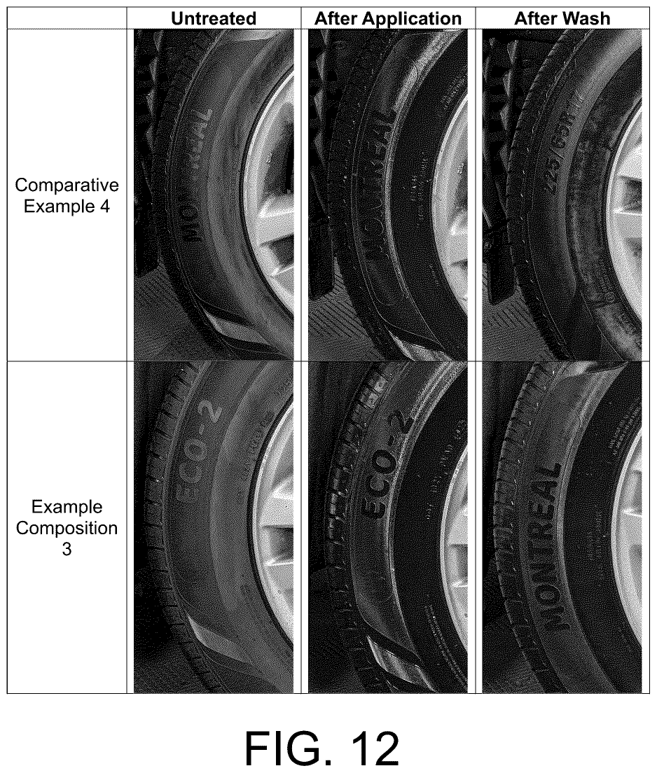

FIG. 12 shows observational images of gloss and wash off durability for each composition tested in Experimental Example 3. FIG. 12 shows compositions of a current product on the market (Comparative Example 4) and the exemplary composition of Experimental Example 3 (Example Composition 3). Images are of a tire before application of the composition (untreated), the tire after application of the composition, and the tire after a brush wash.

### Experimental Example 4

As demonstrated above, the composition of experimental example 3 (Example Composition 3) provided better durability compared to compositions on the market. This was achieved by using high molecular weight silicone, Silicone 1,000 cSt, and using the PEMULEN thickeners system. Experimental example 4 shows tests using a composition with Silicone 12,500 (Example Composition 4) as the high molecular weight silicone. More cyclopentasiloxane was needed in Example Composition 4 compared to Example Composition 3. This is due to the higher viscosity of the Silicone 12,500 cSt.

TABLE 4
Composition of Example Composition 4

| | | Component |
|---|---|---|
| Component | Function | Quantity |
| DI Water | Diluent | 66.266 |
| PEMULEN 1622 | Thickener | 0.1183 |
| Silicone 12,500 cSt | Gloss enhancer | 9.100 |
| Cyclopentasiloxane | Silicone solvent | 14.560 |
| ELKAY 7302 | Low Foaming Wetting Agent | 0.364 |
| Morpholine | Alkaline Neutralizer, VCI | 0.273 |
| Sodium Nitrite | LCI | 0.273 |
| TROYGUARD ™ BC-11 | Preservative | 0.046 |
| Propellant A-70 | Propellant | 9.000 |
| Total | | 100.00 |

The composition of Example Composition 4 was prepared by (a) adding the water to a container and agitating the water; (b) while agitating the water, passing the PEMULEN 1622 powder through a sieve with a mesh screen and adding the PEMULEN 1622 to the water, and mixing for about 60 mins (i.e., until the PEMULEN 1622 powder was well dispersed); (c) forming a preblend by filling a container with the Silicone 12,500 cSt and adding in the Cyclopentasiloxane under constant mixing to adjust the viscosity of the preblend to about 400 cSt to 475 cSt; (d) adding the preblend to the mixture containing water and the PEMULEN 1622 and mixing for about 5 mins; (e) adding the Morpholine and mixing for about 20 minutes, to obtain a homogenous mixture; (f) adding the ELKAY 7302 and mixing for about 15 mins; (g) adding the Sodium Nitrite and mixing for about 10 mins; (h) and adding in the TROYGUARD™ BC-11 and mixing for about 10 mins, to obtain the composition. The composition was then transferred to an aerosol can and the Propellant A-70 was added to the can.

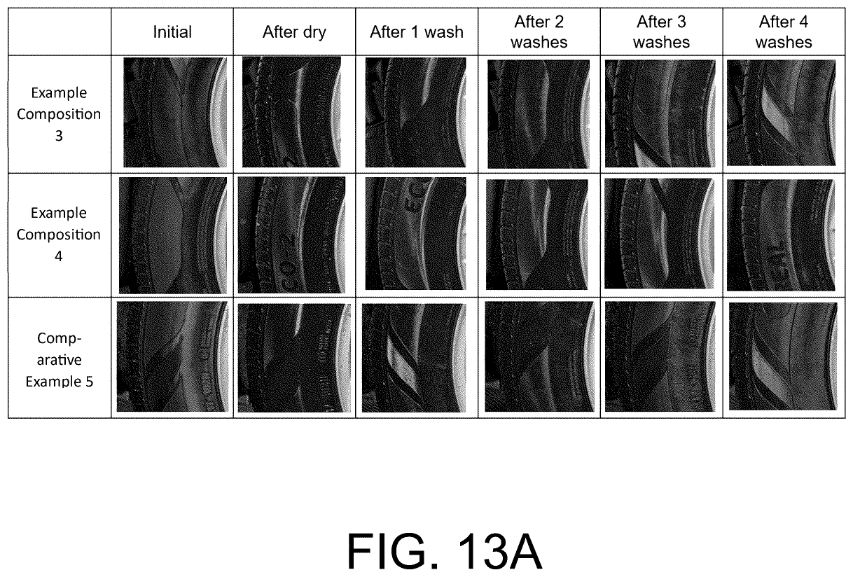

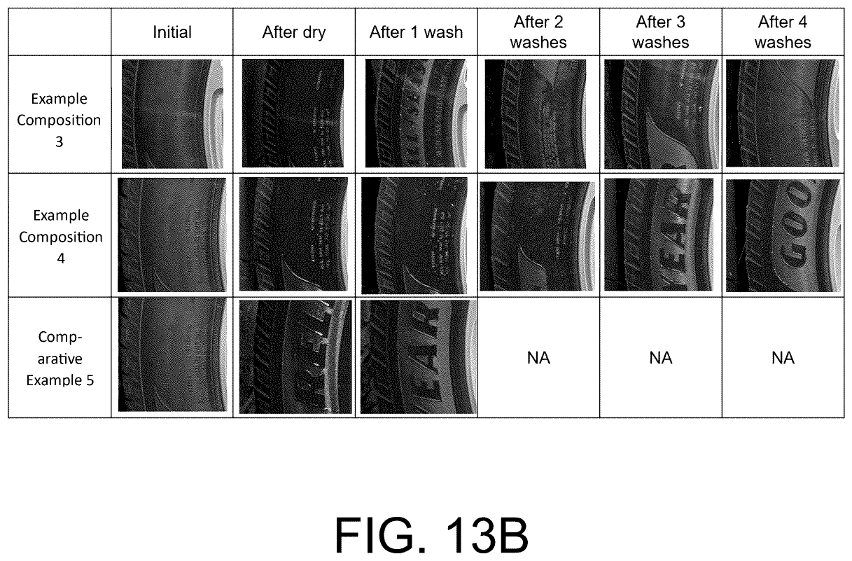

FIGS. 13A and 13B show observational comparisons of the performance of the compositions of Experimental Example 3 (Example Composition 3) and Experimental Example 4 (Example Composition 4) alongside a composition currently available on the market (Comparative Example 5). Performance of the compositions was observed after application and drying of the composition, and after 1 to 4 washes. The term “wash” means the car was run through an automatic car wash with brushes. This is an aggressive wash condition—not only is the car sprayed with soap to clean, it is also physically brushed with brushes and bristles inside the car wash. FIG. 13A shows results on tires from car 1, and FIG. 13B shows results on tires from car 2. Comparative Example 5 is a solvent based aerosol while Example Composition 3 and Example Composition 4 are water based aerosol product. It is believed in the auto care industry that solvent based tire shines are more durable to wash off than water based tire shines. Unexpectedly, however, it can be seen in FIGS. 13A and 13B that both Example Composition 3 and Example Composition 4 are more durable than Comparative Example 5. Additionally, the fact that water based compositions of the present disclosure can last 4 or more washes is unique.

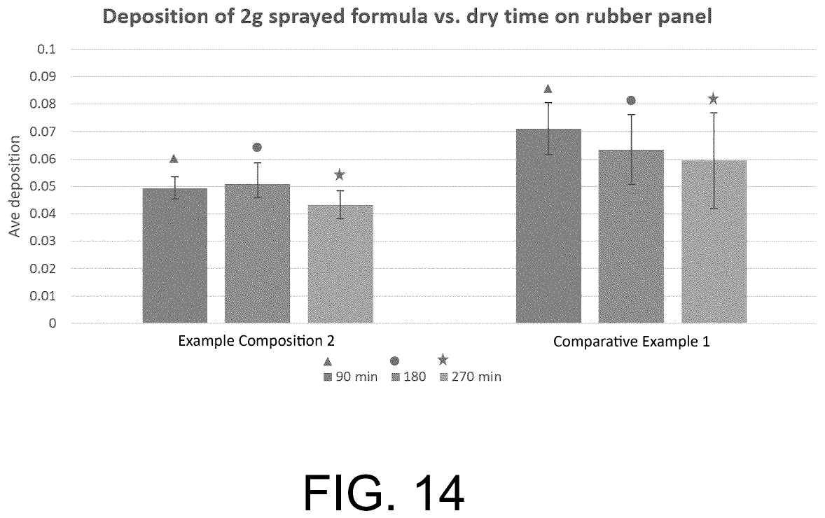

FIG. 14 shows analysis of the deposition of 2 g of sprayed composition versus drying time on a rubber panel. In FIG. 14, a tire shine composition currently on the market (Comparative Example 1) and an exemplary tire shine composition from Experimental Example 2 (Example Composition 2) were tested for drying time. About 2.2-2.6 grams of product was applied on a vertically hung circular SBR disc with a diameter of 5 inches, and sprayed from 6″ from the surface. The surface was allowed to dry for 90 mins, 180 mins, and 270 mins and the average deposition was measured. The test results show that Example Composition 2 has consistent deposition compared to Comparative Example 1, which indicates that the Example Composition 2 composition dries faster than Comparative Example 1. This result provides further insight into how Example Composition 2 and Comparative Example 1 work. Example Composition 2 releases the oil to the surface upon spray and most of the water drains off with the foam, whereas for Comparative Example 1, the composition dries on the surface and the variability in average deposition is due to water taking time to evaporate from the surface.

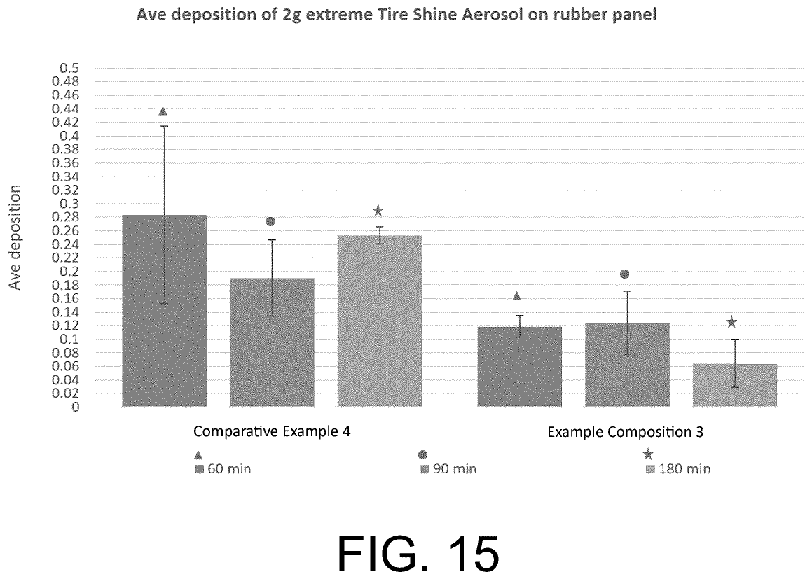

FIG. 15 shows analysis of average deposition of 2 g of Extreme Tire Shine (ETS) aerosol compositions on rubber panels. In FIG. 15, a current extreme tire shine composition on the market (Comparative Example 4) and the composition of Experimental Example 3 (Example Composition 3) were tested for drying time. About 2.2-2.6 grams of product was applied on a vertically hung circular SBR disc with a diameter of 5 inches, and sprayed from 6″ from the surface. The surface was allowed to dry for 60 mins, 90 mins and 180 mins and the average deposition is measured. The test results show that Example Composition 3 has relatively consistent deposition compared to current extreme tire shine (Comparative Example 4) product, which is an indication that Example Composition 3 dries faster than Comparative Example 4. This provides further insight into how Example Composition 3 and Comparative Example 4 work. Example Composition 3 releases the oil to the surface upon spray and most of the water drains off with the foam, whereas for Comparative Example 4 the composition dries on the tire and the variability in average deposition is due to water taking time to evaporate from the surface.

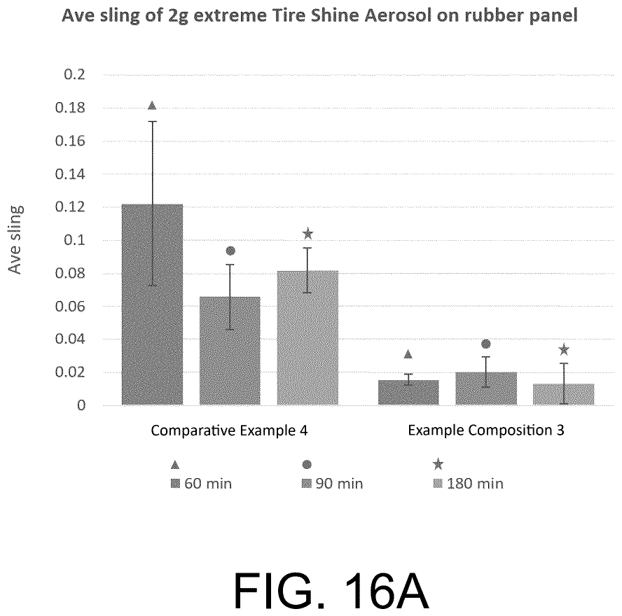

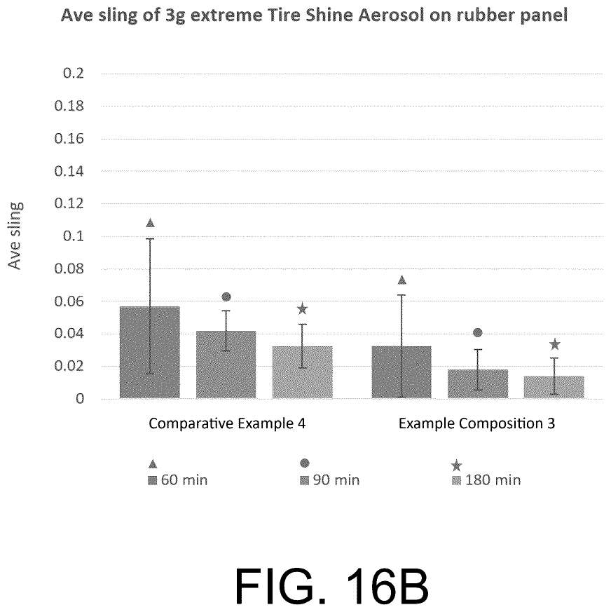

FIGS. 16A and 16B show analysis of average sling off of extreme tire shine (ETS) aerosol compositions on rubber panels. A current extreme tire shine composition on the market (Comparative Example 4) and the composition of Experimental Example 3 (Example Composition 3) were tested for sling off. About 2.2-2.6 grams (FIG. 16A) and 3.2-3.6 grams (FIG. 16B) of product was applied on a vertically hung circular SBR disc with a diameter of 5 inch, and sprayed from 6″ from the surface. The surface was allowed to dry for 60 mins, 90 mins and 180 mins and the average deposition was measured. The disc was then placed in sling instrument for 3 mins. The weight of a fresh parafilm within the sling instrument was recorded before and after spinning to measure the amount of each composition was slung off from the disk onto the film. The test results show that Comparative Example 4 has more sling off compared to the Example Composition 3 composition. This can be correlated to the deposition data shown in FIG. 15, where Comparative Example 4 had an inconsistent dry time. This result shows that Comparative Example 4 holds more water, which gives it higher tendency to sling off if not dried for long periods of time. This data is the average of three panels per time point.

### Experimental Example 5

Experimental Example 5 provides a comparison of a tire shine composition currently on the market (Comparative Example 6), a modified version of the Comparative Example 6 (Comparative Example 7), which includes the same composition as Comparative Example 6 but with reduced amounts of wash-durability affecting components T-Det® A 900, ACUSOL 801 S, and ELKAY AG 177, and a novel tire shine composition (Example Composition 5) according to one embodiment of the present disclosure. The novel tire shine composition (Example Composition 5) of Experimental Example 5 is given in Table 5.

TABLE 5
Composition of Example Composition 5

| | | Component |
|---|---|---|
| Component | Function | Quantity |
| DI Water | Diluent | 78.98951 |
| CARBOPOL 690 | Thickener | 0.093 |
| Silicone 350 cSt | Gloss enhancer | 13.02 |
| BIOSOFT N25-3 | Surfactant | 0.15354 |
| ELKAY 7302 | Low Foaming Wetting Agent | 0.279 |
| Morpholine | Alkaline Neutralizer, VCI | 0.186 |
| Sodium Nitrite | LCI | 0.2325 |
| TROYGUARD ™ BC-11 | Preservative | 0.0465 |
| Propellant A-70 | Propellant | 7.000 |
| Total | | 100.0 |

The composition of Example Composition 5 was prepared by (a) adding the water to a container and agitating the water; (b) while agitating the water, passing the CARBOPOL 690 powder through a sieve with a mesh screen and adding the CARBOPOL 690 to the water, and mixing for about 20 mins (i.e., until the CARBOPOL 690 powder was well dispersed); (c) melt BIOSOFT N25-3 in a heat room at 35° C. Cor above, mix for about 2-10 mins, or about 5 mins, and add the appropriate amount of the product into the tank d) adding Silicone 350 cSt and mix for about 10 mins; (e) add Morpholine and mixing for about 15 mins, at this stage the batch may get extremely thick, increase mixing speed to ensure sufficient fluid motion; (f) adding the ELKAY 7302 and mixing for about 15 mins; (g) reducing the mixing speed and adding in the Sodium Nitrite and TROYGUARD™ BC-11 and mixing for about 20 mins, to obtain the composition. The composition was then transferred to an aerosol can and the Propellant A-70 was added to the can.

The thickener, e.g., CARBOPOL 690 polymer powder, PEMULEN 1621 polymer powder, and PEMULEN 1622 polymer powder, can be stored in dry conditions and sealed well after it is opened. Clumping and improper hydration of the polymer during processing may occur if the thickener powder acquires moisture, leading to inadequate viscosity. The surfactant, e.g., BIOSOFT N25-3, is melted prior to batching. This chemical cannot be pre-weighed in advance. If needed, the surfactant, e.g., BIOSOFT N25-3, may be melted prior to batching, for example if the surfactant is stored at a temperature below the freezing point of the surfactant. The surfactant may be mixed for 5 mins and then an appropriate amount of the surfactant can be weighed and added into the tank in order to improve foaming and dust masking capability of the composition. The composition can be made in tanks with baffles and appropriate mixing blades in order to produce a homogeneous mixture with good performance. In some cases, the thickener can be added at the end of the batch, for example to improve the viscosity of the batch.

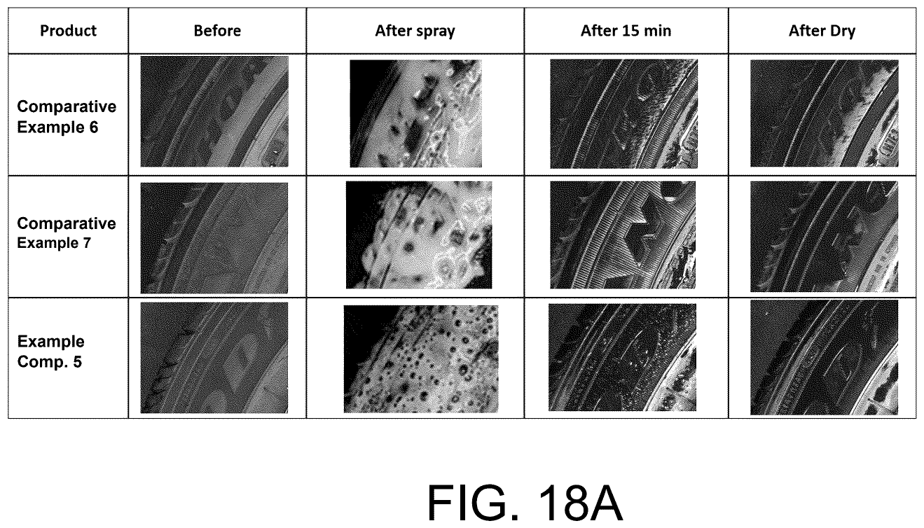

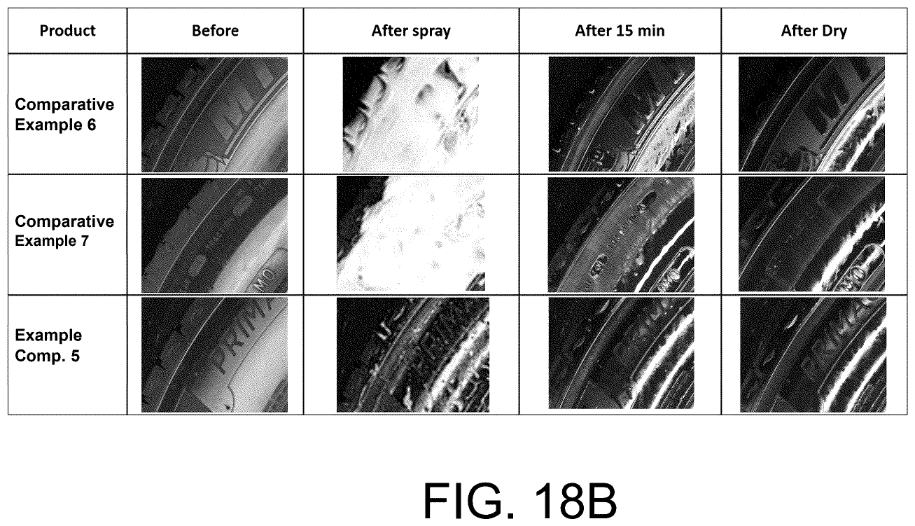

FIGS. 18A and 18B show foam flow down observations on tires of a first car (FIG. 18A) and a second car (FIG. 18B). Observational images of Comparative Example 6, Comparative Example 7, and Example Composition 5 are shown before products are applied, after spraying each respective product, after 15 minutes, and after the tires were completely dry.

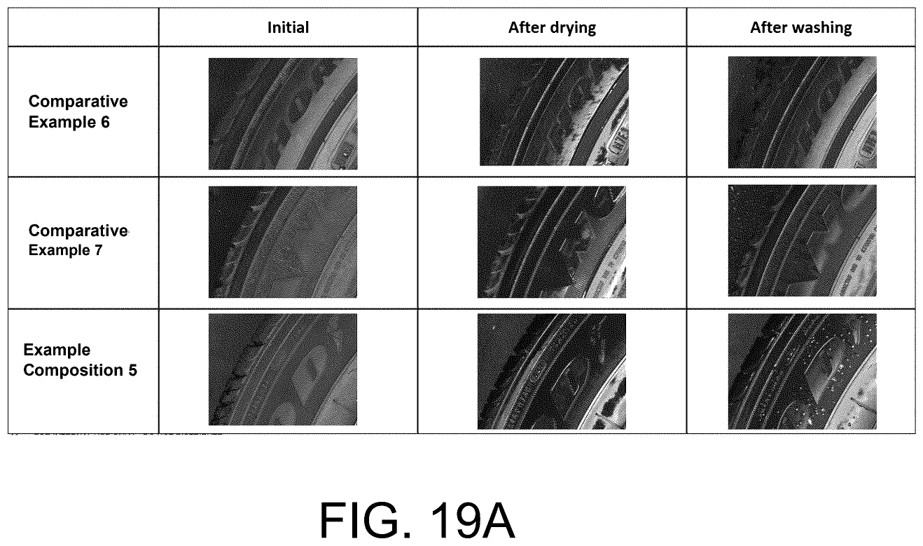

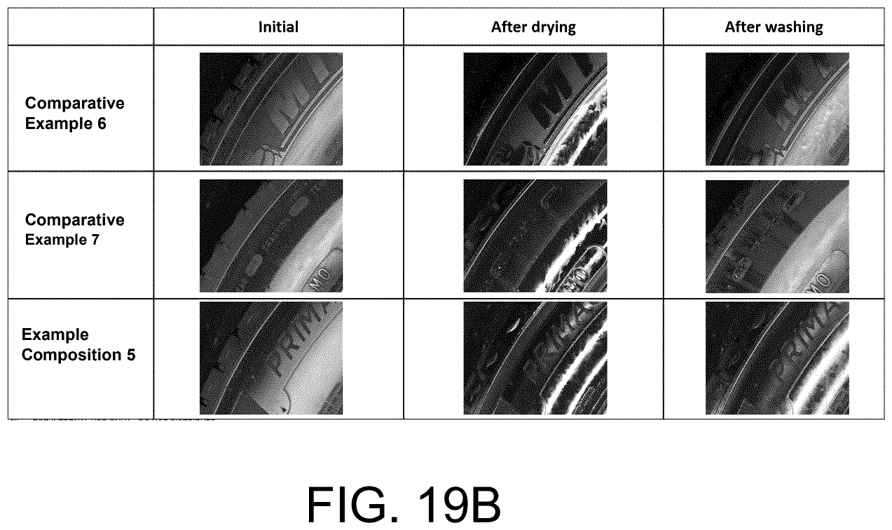

FIGS. 19A and 19B show wash durability observations for compositions applied to clean tires of a first car (FIG. 19A) and a second car (FIG. 19B). Observational images of Comparative Example 6, Comparative Example 7, and Example Composition 5 are shown before products are applied, after spraying each respective product and allowing each tire to dry, and after washing each tire. Products were applied in a clockwise direction 6 times for each observation.

FIGS. 20A and 20B show wash durability observations on unclean tires of a first car (FIG. 20A) and a second car (FIG. 20B). Observational images of Comparative Example 6, Comparative Example 7, and Example Composition 5 are shown before products are applied, after spraying each respective product and allowing each tire to dry, and after washing each tire. Products were applied in a clockwise direction 6 times for each observation.

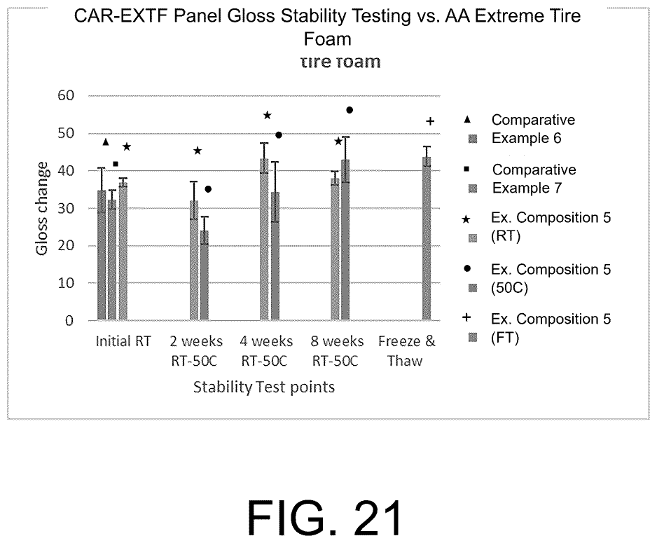

FIG. 21 shows gloss analysis using SBR panels. Comparative Example 6, Comparative Example 7, Example Composition 5 (room temperature, about 23° C. (RT)), Example Composition 5 (50° C.) and Example Composition 5 (freeze & thaw (FT)) were tested for gloss using a Rhopoint gloss meter. 3-3.5 grams (aerosol) of product is applied on a 5″×5″ SBR panel hung vertically and sprayed from 6″ from the surface. The surface is allowed to dry for 60 mins and gloss is measured using Rhopoint gloss meter. This data is the average of two panels per sample. All the testing for Example Composition 5 was done with SV-92 valve and V-80 0.02×0.04 actuator from Summit. Testing indicates that Example Composition 5 is equivalent to the Comparative Example 6 and Comparative Example 7 in terms of gloss performance. However, the test also demonstrates better spreading than the Comparative Example 6 & faster drying time than both (Comparative Example 6 and Comparative Example 7). Example Composition 5 shows good gloss stability over time at RT, 50° C. & FT. While FIG. 21 shows some variation in gloss values over time, this is due to variability panel to panel.

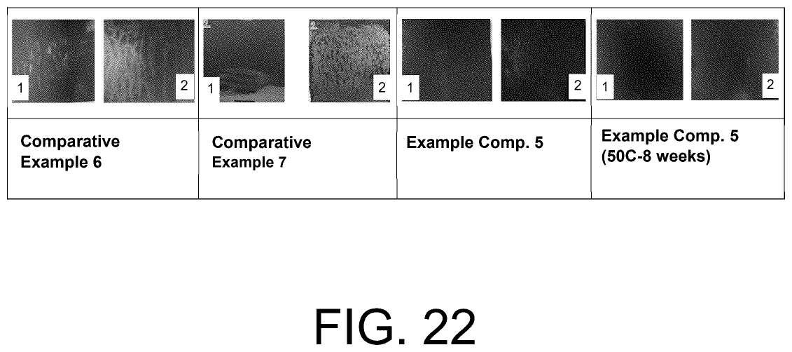

FIG. 22 shows gloss and wash durability observations on SBR panels. The images labeled 1, indicate the panels after application and drying of the product and the images labeled 2 indicate the panels after washing under tap water (no soap) for 1 min and drying. Table 5A presents analysis for gloss and wash durability of the SBR panels depicted in FIG. 22. This data is the average of two panels per sample.

TABLE 5A
Gloss and wash durability product analysis.

| | | | | Example |
|---|---|---|---|---|
| | Comparative | Comparative | Example | Composition 5 |
| Product Name | Example 6 | Example 7 | Composition 5 | (50° C.-8 weeks) |
| Amount | 3.3 | 3.3 | 3.37 | 3.33 |
| of composition | | | | |
| sprayed (g)* | | | | |
| Appearance | non-uniform | Glossy and | Uniform glossy | Uniform glossy |
| after drying | glossy surface, | Uniform | surface, slight | surface |
| | streaky | | spotting | |
| appearance after | Mostly gone, dry | Mostly gone, dry | Gloss surface, | Uniform glossy |
| wash under tap | streaks left | streaks left | slight spotting | surface |
| water for 1 min | | | | |

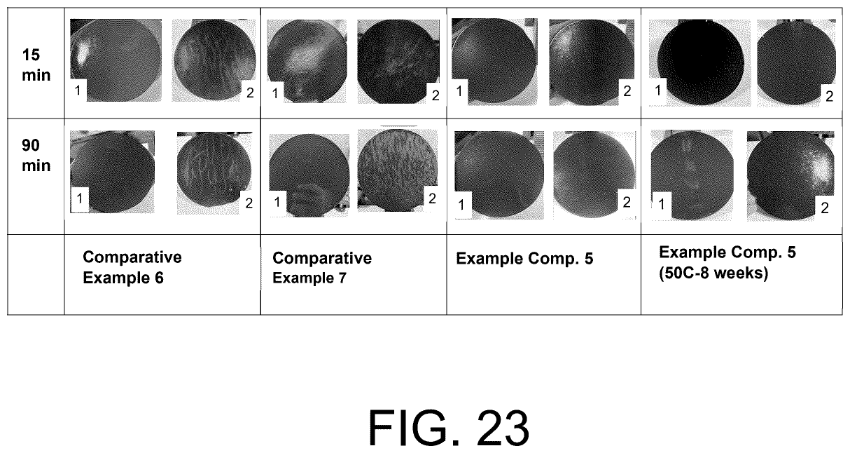

FIG. 23 shows spin and wash durability observations on SBR panels. The images labeled 1, indicate the panels after application, drying of the product for either 15 mins (top) or 90 mins (bottom), and spinning. The images labeled 2 indicate the panels after washing under tap water (no soap) for 1 min and drying. Table 5B presents analysis for spin and wash durability of the SBR panels depicted in FIG. 23. This data is the average of two panels per sample.

TABLE 5B
Spin and wash durability product analysis.

| | | | | Example |
|---|---|---|---|---|
| | Comparative | Comparative | Example | Composition 5 |
| Product Name | Example 6 | Example 7 | Composition 5 | (50° C.-8 weeks) |
| Amount sprayed | 3.4/3.25 | 3.4/3.4 | 3.28/3.45 | 3.31/3.44 |
| (g)* | | | | |
| (15 min dry/90 | | | | |
| min dry) | | | | |
| Appearance after | Not dry, foam | Not dry, foam | Mostly dry, | Dry, Uniform |
| drying and spin | residue on | residue on surface, | uniform gloss/ | glossy surface |
| (15 min dry/90 | surface, streaky/ | streaky/Dry, | Dry, uniform | slight spotting/ |
| min dry) | Dry, non-uniform | uniform glossy, no | glossy surface | Dry, Uniform |
| | glossy surface, | streaks | slight spotting | glossy surface |
| | streaky | | | slight spotting |
| Appearance after | Composition gone, | Mostly washed off, | Slight wash off | Slight wash off |
| spin and wash (15 | dry streaks | streaky slight oil | Spotty, glossy | Spotty, glossy |
| min dry), 1 min | | residue on the | | |
| wash | | edges | | |
| Appearance after | Mostly washed off, | Mostly washed off, | Slight wash off | Slight wash off |
| spin and wash (90 | dry streaks slight | streaky | Spotty, glossy | Spotty, glossy |
| mins dry) 1 min | gloss | | | |
| wash | | | | |

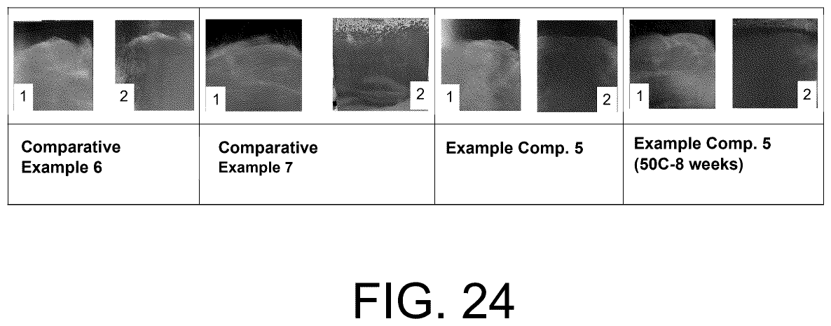

FIG. 24 shows dust masking performance observations on SBR panels. To simulate and test dirt masking on tires, 0.02-0.025 grams of black charm clay was applied on SBR sheets and spread evenly using a sponge. The dusted panels are then sprayed with 2-2.5 grams of the composition and allowed to dry for 15-30 mins and observations are made. The goal is to see if the dust has been fully masked by the composition to give the appearance of a clean tire. Table 5C presents analysis for dust masking performance of the SBR panels depicted in FIG. 23. This data is the average of two panels per sample.

TABLE 5C
Dust masking performance product analysis.

| | | | | Example |
|---|---|---|---|---|
| | Comparative | Comparative | Example | Composition 5 |
| Product Name | Example 6 | Example 7 | Composition 5 | (50° C.-8 weeks) |
| Amount sprayed (g)* | 2-2.5 | 2-2.5 | 2-2.5 | 2-2.5 |
| Appearance after | Streaky slight | Uniform Dust | Uniform dust | Uniform dust |
| drying | dust masking | Masking | masking | masking |

A novel tire shine composition of the present disclosure (Example Composition 6) is given in Table 6A.

TABLE 6A
Composition of Example Composition 6

| | | Component |
|---|---|---|
| Component | Function | Quantity |
| DI Water | Diluent | 84.935 |
| CARBOPOL 690 | Thickener | 0.1 |
| Silicone 350 cSt | Gloss enhancer | 14 |
| BIOSOFT N25-3 | Surfactant | 0.165 |
| ELKAY 7302 | Low Foaming Wetting Agent | 0.30 |
| Morpholine | Alkaline Neutralizer, VCI | 0.2 |
| Sodium Nitrite | LCI | 0.25 |
| TROYGUARD ™ BC-11 | Preservative | 0.05 |
| Total | | 100 |

The novel tire shine composition of Example Composition 6 including a propellant is given in Table 6B.

TABLE 6B
Composition of Example Composition 6 with propellant

| | | Component |
|---|---|---|
| Component | Function | Quantity |
| DI Water | Diluent | 78.9896 |
| CARBOPOL 690 | Thickener | 0.093 |
| Silicone 350 cSt | Gloss enhancer | 13.02 |
| BIOSOFT N25-3 | Surfactant | 0.1534 |
| ELKAY 7302 | Low Foaming Wetting Agent | 0.279 |
| Morpholine | Alkaline Neutralizer, VCI | 0.186 |
| Sodium Nitrite | LCI | 0.2325 |
| TROYGUARD ™ BC-11 | Preservative | 0.046 |
| Propellant A-70 | Propellant | 7 |
| Total | | 100 |

The composition of Example Composition 6 was prepared by (a) adding the water to a container and agitating the water; (b) while agitating the water, passing the CARBOPOL 690 powder through a sieve with a mesh screen and adding the CARBOPOL 690 to the water, and mixing for about 20 mins (i.e., until the CARBOPOL 690 powder was well dispersed); (c) melt BIOSOFT N25-3 in a heat room at 3° C. or above, mix for few mins, e.g., about 10 mins to about 15 mins, and add the appropriate amount of the product into the tank d) adding Silicone 350 cSt and mix for about 10 mins; (e) add Morpholine and mixing for about 15 mins, at this stage the batch may get extremely thick, increase mixing speed to ensure sufficient fluid motion; (f) adding the ELKAY 7302 and mixing for about 15 mins; (g) reducing the mixing speed and adding in the Sodium Nitrite and TROYGUARD™ BC-11 and mixing for about 20 mins, to obtain the composition. The composition was then transferred to an aerosol can and the Propellant A-70 was added to the can.

Another example of a novel tire shine composition of the present disclosure (Example Composition 7) is given in Table 7A.

TABLE 7A
Composition of Example Composition 7

| | | Component |
|---|---|---|
| Component | Function | Quantity |
| DI Water | Diluent | 85.82 |
| CARBOPOL 690 | Thickener | 0.13 |
| Silicone 1000 cSt | Gloss enhancer | 10 |
| Cyclopentasiloxane | Silicone Solvent | 3.0 |
| ELKAY 7302 | Low Foaming Wetting Agent | 0.4 |
| Morpholine | Alkaline Neutralizer, VCI | 0.3 |
| Sodium Nitrite | LCI | 0.3 |
| TROYGUARD ™ BC-11 | Preservative | 0.05 |
| Total | | 100 |

The novel tire shine composition of Example Composition 7 including a propellant is given in Table 7B.

TABLE 7B
Composition of Example Composition 7 with propellant

| | | Component |
|---|---|---|
| Component | Function | Quantity |
| DI Water | Diluent | 78.0962 |
| CARBOPOL 690 | Thickener | 0.1183 |
| Silicone 1000 cSt | Gloss enhancer | 9.1 |
| Cyclopentasiloxane | Silicone Solvent | 2.73 |
| ELKAY 7302 | Low Foaming Wetting Agent | 0.364 |
| Morpholine | Alkaline Neutralizer, VCI | 0.273 |
| Sodium Nitrite | LCI | 0.273 |
| TROYGUARD ™ BC-11 | Preservative | 0.0455 |
| Propellant A-70 | Propellant | 9 |
| Total | | 100 |

The composition of Example Composition 7 can be prepared by (a) adding the water to a container and agitating the water; (b) while agitating the water, passing the CARBOPOL 690 powder through a sieve with a mesh screen and adding the CARBOPOL 690 to the water, and mixing for about 60 mins (i.e., until the CARBOPOL 690 powder was well dispersed); (c) forming a preblend by filling a container with the Silicone 1000 cSt and adding in the Cyclopentasiloxane under constant mixing to adjust the viscosity of the preblend to about 400 cSt to 475 cSt; (d) adding the preblend to the mixture containing water and the CARBOPOL 690 and mixing for about 5 mins; (e) adding the Morpholine and mixing for about 20 minutes, to obtain a homogenous mixture; (f) adding the ELKAY 7302 and mixing for about 15 mins; (g) adding the Sodium Nitrite and mixing for about 10 mins; (h) and adding in the TROYGUARD™ BC-11 and mixing for about 10 mins, to obtain the composition. The composition can then be transferred to an aerosol can and the Propellant A-70 was added to the can.

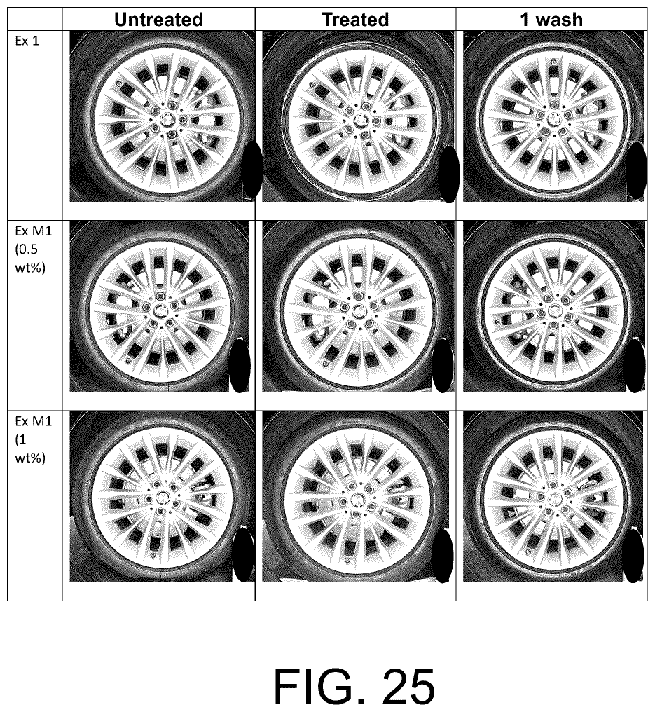

Exemplary compositions of the present disclosure including mattifying agents are shown in FIG. 25. A first example composition (Ex 1) is the composition of Example Composition 3 Exemplary Compositions Ex M1 and Ex M2 of the present disclosure are modifications of Example Composition 7 (i.e., including Carbopol 690 as a thickener, Silicone 1000 cSt as a gloss enhancer) that also include 10 micron Hydrophobic Silica Particles (SIPERNATE 17) as mattifying agent. Ex M1 includes 0.5 wt % of mattifying agent and Ex M2 includes 1 wt % of mattifying agent. In FIG. 25 it can be seen that the mattifying effect is controllable by adjusting the Silica content and that the surface tends to get slightly glossier after multiple wash cycles. Mattifying agents can be used to reduce tackiness of coating, leading to lower dirt adhesion.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It is to be understood that the examples and exemplary embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art.

Furthermore, numerous references have been made to patents, printed publications, journal articles, and other written text throughout this specification (referenced materials herein). Each of the referenced materials is individually incorporated herein by reference in their entirety for their referenced teaching.

1. A composition comprising:
(a) water; one or more thickeners; one or more wetting agents; one or more corrosion inhibitors; one or more pH adjusters; one or more gloss enhancers; and one or more silicone solvent; and optionally, one or more preservatives and/or one or more propellants; or
(b) by total weight of the composition:
about 70.00% to 90.00% water;
about 0.05% to 0.50% of one or more thickeners;
about 0.05% to 1.00% of one or more wetting agents;
about 0.05% to 1.00% of one or more corrosion inhibitors;
about 0.05% to 1.00% of one or more pH adjusters;
about 5.00% to 30.00% of one or more gloss enhancers having a viscosity of between about 500 cSt to 2,000,000 cSt; and
about 1.00% to 30.00% of one or more silicone solvents; and
optionally:
about 0.01% to 0.10% of one or more preservatives; and/or
about 5.00% to 10.00% hydrocarbon based propellant.

2. The composition of claim 1, wherein the water is distilled water, deionized water, or reverse osmosis water.

3. The composition of claim 1, wherein the one or more thickeners comprises a poly(vinyl pyrrolidone/acrylic acid), acrylate polymer, acrylic acid based polymer, and acrylic-acid based copolymer.

4. The composition of any one of claim 1, wherein the one or more thickeners comprises a crosslinked, polyacrylic acid polymer, and optionally wherein the crosslinked polyacrylic acid polymer comprises a highly crosslinked, polyacrylic acid homopolymer or crosslinked, hydrophobically modified acrylic acid copolymer.

5. The composition of claim 4, wherein the highly crosslinked, polyacrylic acid homopolymer comprises 2-propenoic acid homopolymer; or wherein the crosslinked, hydrophobically modified acrylic acid copolymer comprises a moderately crosslinked, hydrophobically modified copolymer of acrylic acid and C10-C30 alkyl acrylate or a lightly crosslinked, hydrophobically modified copolymer of acrylic acid and C10-C30 alkyl acrylate.

6. The composition of claim 1, wherein the one or more wetting agents comprise a low foaming wetting agent.

7. The composition of claim 1, wherein the one or more wetting agents comprise a silicone polyether copolymer, and optionally wherein the silicone polyether copolymer comprises dimethylsiloxane ethylene oxide block copolymer.

8. The composition of claim 1, wherein the one or more corrosion inhibitors comprise an inorganic inhibitor and organic inhibitor, and optionally, wherein the one or more corrosion inhibitors comprise a nitrite, nitrate, phosphate, chromate, and molybdate.

9. The composition of claim 8, wherein the one or more corrosion inhibitors comprise a low-odor corrosion (LCI) inhibitor; and optionally, wherein the LCI is sodium nitrite.

10. The composition of claim 1, wherein the one or more pH adjusters comprise tri(hydroxymethyl)amino methane (TRIS), 2-amino-2-ethyl-1,3-propanedi-ol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine), morpholine, and morpholine derivative.

11. The composition of claim 1, wherein the one or more pH adjusters comprise a volatile corrosion inhibitor (VCI); and optionally, wherein the VCI comprises morpholine or a morpholine derivative.

12. The composition of claim 1, wherein the one or more preservatives comprise hydantoin germicide, carbamate fungicide, benzisothiazolinone (BIT), methylisothiazolinone (MIT), methylchloroisothiazolinone (CMIT), and a combination thereof; and optionally, the one or more preservatives comprise a combination of BIT, MIT, and CMIT.

13. The composition of claim 1, wherein the one or more propellants comprise a hydrocarbon based propellant, nitrogen propellant, and dimethyl ether propellant; and optionally, wherein the one or more propellants comprise a blend of propane and isobutane and having a vapor pressure of about 70 psig at about 70° F.

14. The composition of claim 1, wherein the one or more gloss enhancers comprise one or more silicone oils; and optionally wherein the viscosity of the one silicone oil or a mixture of two or more silicone oils has a viscosity of about 1,000 cSt, or about 12,500 cSt.

15. The composition of claim 14, wherein the one or more silicone oils comprise one or more polyorganosiloxanes; and optionally, wherein the one or more gloss enhancers comprise a polydimethylsiloxane, polydiethylsiloxane, and polyalkylarylsiloxane.

16. The composition of claim 1, wherein the one or more silicone solvents comprise one or more cyclic siloxanes, and optionally the one or more cyclic siloxanes comprise cyclopentasiloxane (decamethylcyclopentasiloxane, D5), octamethylcyclotetrasiloxane (D4), or D6-dodecamethylcyclohexasiloxane (D6).

17. The composition of claim 1, wherein the composition comprises:
(a) deionized water; lightly crosslinked, hydrophobically modified copolymer of acrylic acid and C10-C30 alkyl acrylate, or highly crosslinked, polyacrylic acid homopolymer; dimethylsiloxane ethylene oxide block copolymer; sodium nitrite; morpholine; silicone oil with a viscosity of about 1,000 cSt or about 12,500 cSt; and cyclopentasiloxane; and optionally, preservative comprising BIT, MIT, and CMIT; and/or hydrocarbon based propellant; or
(b) by total weight of the composition:
about 70.00% to 85.00% deionized water;
about 0.05% to 0.50% lightly crosslinked, hydrophobically modified copolymer of acrylic acid and C10-C30 alkyl acrylate, or highly crosslinked, polyacrylic acid homopolymer;
about 0.05% to 1.00% dimethylsiloxane ethylene oxide block copolymer;
about 0.05% to 1.00% sodium nitrite;
about 0.05% to 1.00% morpholine;
about 5.00% to 30.00% silicone oil with a viscosity of about 1000 cSt or about 12,000 cSt; and
about 1.00% to 30.00% cyclopentasiloxane; and
optionally:
about 0.01% to 0.10% preservative comprising BIT, MIT, and CMIT; and/or
about 5.00% to 10.00% hydrocarbon based propellant.

18. The composition of claim 1, wherein the composition comprises by total weight of the composition:
(a) about 78.0957% deionized water;
about 0.1183% lightly crosslinked, hydrophobically modified copolymer of acrylic acid and C10-C30 alkyl acrylate;
about 0.364% dimethylsiloxane ethylene oxide block copolymer;
about 0.273% sodium nitrite;
about 0.273% morpholine;
about 9.1% silicone oil with a viscosity of about 1,000 cSt;
about 2.73% cyclopentasiloxane;
about 0.046% preservative comprising BIT, MIT, and CMIT; and
about 9.00% propellant comprising a blend of propane and isobutane and having a vapor pressure of about 70 psig at about 70° F.;
(b) about 66.266% deionized water;
about 0.1183% lightly crosslinked, hydrophobically modified copolymer of acrylic acid and C10-C30 alkyl acrylate;
about 0.364% dimethylsiloxane ethylene oxide block copolymer;
about 0.273% sodium nitrite;
about 0.273% morpholine;
about 9.1% silicone oil with a viscosity of about 12,500 cSt;
about 14.56% cyclopentasiloxane;
about 0.046% preservative comprising BIT, MIT, and CMIT; and
about 9.00% propellant comprising a blend of propane and isobutane and having a vapor pressure of about 70 psig at about 70° F.; or
(c) about 78.0962% deionized water;
about 0.1183% highly crosslinked, polyacrylic acid homopolymer;
about 0.364% dimethylsiloxane ethylene oxide block copolymer;
about 0.273% sodium nitrite;
about 0.273% morpholine;
about 9.1% silicone oil with a viscosity of about 1,000 cSt;
about 2.73% cyclopentasiloxane;
about 0.0455% preservative comprising BIT, MIT, and CMIT; and
about 9.00% propellant comprising a blend of propane and isobutane and having a vapor pressure of about 70 psig at about 70° F.

19. The composition of claim 1, wherein the composition further comprises fragrance, one or more ultraviolet (UV) inhibitors, one or more aesthetic agents, or a combination thereof; and optionally, wherein the one or more aesthetic agents include a dye, a lustrous particle, a mattifying agent, a magnetic particle, or a combination thereof.

20. A method of preparing the composition of claim 1, wherein the method comprises (a) adding water to a container and agitating the water; (b) while agitating the water, adding the one or more thickeners to the water and mixing until the one or more thickeners are dispersed to form a mixture, and optionally passing the one or more thickeners through a sieve before adding to the water; (c) forming a preblend by filling a separate container with one or more gloss enhancers and adding in one or more silicone solvents under constant mixing to adjust the viscosity of the preblend to about 100 cSt to 500 cSt, about 300 cSt to 500 cSt, or about 420 cSt to 440 cSt; (d) adding the preblend to the mixture containing the water and the thickeners; (e) adding one or more pH adjusters and mix to obtain a homogeneous mixture; (f) adding one or more wetting agents and mix; and (g) adding one or more corrosion inhibitors; and optionally adding one or more preservatives.

21. The method of claim 20, wherein the method further comprises adding fragrance, one or more UV inhibitors, one or more aesthetic agents, or a combination thereof; and optionally, wherein the one or more aesthetic agents include a dye, a lustrous particle, a mattifying agent, a magnetic particle, or a combination thereof.

22. The method of claim 20, wherein the method further comprises placing the prepared composition in an aerosol can and filling the aerosol can with hydrocarbon based propellant, nitrogen propellant, or dimethyl ether propellant.

23. A method of providing shine and/or durable protection to a surface, wherein the method comprises applying the composition of claim 1 to the surface and allowing the surface to dry.

24. The method of claim 23, wherein applying the composition comprises spraying the composition on the surface and wherein the composition dries in about 30 seconds to 15 minutes, and optionally, wherein the composition dries within one minute.

25. The method of claim 23, wherein the surface is a rubber surface, vinyl surface, leather surface, plastic surface, or painted surface; and optionally, wherein the surface is a tire or trim.

26. The method of claim 23, wherein the method provides durable gloss to the surface even after about 1 to 10 washes.

27. The method of claim 23, when the composition is applied in a single step and does not require wiping.
